(19) United States
(12) Patent Application Publication
(10) Pub. No.: US 2024/0185821 A1
(43) Pub. Date: Jun. 6, 2024

(54) SOUND SOURCE DEVICE FOR ELECTRONIC MUSICAL INSTRUMENT, MUSICAL SOUND GENERATING METHOD AND ELECTRONIC MUSICAL INSTRUMENT SYSTEM

(71) Applicants: Roland Corporation, Shizuoka (JP); Drum Workshop, Inc., Oxnard, CA (US)

(72) Inventors: Ryo Takasaki, Shizuoka (JP); Kou Imai, Shizuoka (JP); Kenji Morita, Shizuoka (JP); Toshiharu Kimura, Shizuoka (JP); Paul Piscoi, Dumbråvita (RO)

(73) Assignees: Roland Corporation, Shizuoka (JP); Drum Workshop, Inc., Oxnard, CA (US)

(21) Appl. No.: 18/421,918

(22) Filed: Jan. 24, 2024

Related U.S. Application Data
(63) Continuation-in-part of application No. 18/224,529, filed on Jul. 20, 2023.
Application No. 18/224,529 is a continuation of application No. 17/546,046, filed on Dec. 9, 2021, now Pat. No. 11,756,519.
Application No. 17/546,046 is a continuation of application No. 16/603,248, filed on Oct. 7, 2019, now Pat. No. 11,232,774.

(51) Int. Cl. G10H 7/00; G10H 1/00; G10H 1/32

(52) U.S. Cl. CPC G10H 7/008; G10H 1/0008; G10H 1/32; G10H 2210/066; G10H 2240/161

(57) ABSTRACT

A sound source device for an electronic musical instrument includes processing electronics to provide at least one virtual input port, assign a different respective tone or other effect to each virtual input port, associate each respective first playing operation device of a musical instrument system with a respective virtual input port, and receive first playing information from at least one of the first playing operation devices. A musical sound generating unit generates a musical sound signal on the basis of the first playing information received and the tone or other effect assigned to the respective virtual input port associated with the first playing operation device.

### CROSS-REFERENCE TO RELATED PATENT APPLICATIONS

This application is a continuation-in-part of, and claims the priority benefit to, U.S. Ser. No. 18/224,529, filed Jul. 20, 2023, which is a continuation application of, and claims the priority benefit to, U.S. Ser. No. 17/546,046, filed on Dec. 9, 2021, now U.S. Pat. No. 11,756,519, which is a continuation application of, and claims the priority benefit to, U.S. Ser. No. 16/603,248, filed on Oct. 7, 2019, now U.S. Pat. No. 11,232,774, which is a 371 application of, and claims the priority benefit to International PCT Application Serial No. PCT/JP2017/015098, filed on Apr. 13, 2017. The entirety of each of the above-mentioned patents and patent applications is hereby incorporated by reference herein and made a part of this specification.

### BACKGROUND AND OVERVIEW

The present disclosure relates to sound source devices for electronic musical instruments, and to electronic musical instrument systems and methods that include or employ those sound source devices and electronic musical instruments. In certain examples described herein, the electronic musical instrument is an electronic drum or an electronic drum set or kit. However, in other examples, the sound source device may be configured to be used with, or is included in, other types of electronic musical instruments and electronic musical instrument systems.

In certain examples, a sound source device may be configured to connect for communication with, or is included in, an electronic drum set or kit and is configured to receive signals that are output from one or more (or a plurality of) electronic pads of the electronic drum set or kit. An electronic pad may include an electronic drum pad, an electronic cymbal pad, an electronic hi-hat, or other suitable electronic device that outputs an electrical signal based on a vibration of a striking surface that has been struck or beaten. Sound source devices according to certain examples described herein are configured to generate a musical sound signal having a tone or other effect assigned to a pad (or other instrument), based on a signal output from the pad (or other instrument). In examples described herein, a pad or other instrument may be referred to herein as a playing operation device.

In particular examples described herein, a sound source device of or for an electronic drum set or kit assigns a tone or other effect to a pad of the electronic drum set or kit in accordance with a connection terminal (input port) to which the pad is connected for communication, from among a plurality of connection terminals (input ports) disposed in the sound source device. In other examples described herein, a sound source device assigns a tone or other effect to a pad (or other instrument) in accordance with a pad (instrument) identifier received by the sound source device, where the pad (instrument) identifier is from among a plurality of pad (instrument) identifiers that can be recognized by the sound source device. In some examples, the pad (instrument) identifier and instrument signals are received by the sound source device through a wireless communication connection with an electronic module associated with the pad (or other instrument). Accordingly, in certain examples, one or more, or a plurality of pads (or other instruments) may be connected by wire connections to a corresponding plurality of connection terminals of the sound source device. Alternatively, or in addition, one or more, or a plurality of pads (or other instruments) may be connected to the sound source device by wireless connections through associated wireless communication units. A different tone or other effect may be assigned to each different pad (or other instrument) based on its connection terminal or based on the pad (instrument) identifier received from the pad. Certain examples described herein are configured to increase the degree of freedom of setting and assigning a tone to each connected pad (or other musical instrument device) in a manner that can be easily understood by a user.

An electronic musical instrument system according to certain examples described herein includes one or more drum pads or other playing operation devices (also referred to herein as instruments) that generate playing information, and a sound source device to which each playing operation device is connected. The sound source device may include any suitable combination of some or each of: a plurality of physical connection terminals; a wireless receiver or transceiver; a tone assigning unit; a connection detecting unit; an information acquiring unit; a port assigning unit; and a musical sound generating unit. Each drum pad or other playing operation device is connected (or configured to connect) to a respective one of the plurality of physical connection terminals of the sound source device, or is connected (or configured to connect) for wireless communication with the wireless receiver or transceiver of the sound source device. In the sound source device, virtual input ports are provided, including a respective virtual input port for each type of drum pad or other playing operation device. The tone assigning unit assigns a respective tone or other effect of a generated sound based on playing information input to each respective virtual input port. The connection detecting unit detects that the drum pad or other playing operation device is connected to one of the connection terminals. Alternatively, the connection detecting unit detects a wireless communication connection with the drum pad or other playing operation device. The information acquiring unit, in a case in which it is detected by the connection detecting unit that the drum pad or other playing operation device (instrument) is connected to the sound source device, acquires information relating to the playing operation device from the connected playing operation device. In certain examples, the port assigning unit assigns the virtual input port of a type corresponding to the information relating to the playing operation device acquired by the information acquiring unit to the playing operation device of which the connection with the sound source device is detected by the connection detecting unit. The musical sound generating unit generates a musical sound signal of a tone or other effect assigned by the tone assigning unit to the virtual input port assigned to the playing operation device by the port assigning unit on the basis of the playing information acquired from the playing operation device connected to the connection terminal or connected by the wireless communication connection.

In the sound source device, a virtual input port may be provided for each type of drum pad or other playing operation device separately from a physical connection terminal or a wireless communication link to which each playing operation device is connected. To each virtual input port, a tone or other effect of a sound generated on the basis of playing information input to the input port may be assigned by the tone assigning unit. In a case in which it is detected by the connection detecting unit that the playing operation device is connected to the sound source device via one of the connection terminals or via a wireless communication connection, information relating to the playing operation device is acquired by the information acquiring unit from the connected playing operation device. Then, a virtual input port of a type corresponding to the information relating to the playing operation device acquired by the information acquiring unit is assigned by the port assigning unit to the playing operation device of which connection has been detected by the connection detecting unit. When playing information is acquired from the playing operation device connected to the connection terminal or to the wireless communication connection, a musical sound signal of a tone or other effect assigned by the tone assigning unit to the virtual input port assigned to the playing operation device by the port assigning unit is generated by the musical sound generating unit on the basis of the playing information. Accordingly, a degree of freedom of tone or other effect setting for a drum pad or other playing operation device connected to a sound source device can be increased, and there is an effect of being capable of performing assignment of a tone or other effect such that it can be easily understood by a user.

### BRIEF DESCRIPTION OF THE DRAWINGS

FIG. 1 is a schematic diagram illustrating an image of an entire electronic drum system including a sound source device according to one embodiment of the present invention.

FIG. 2 is a schematic diagram schematically illustrating a rear panel disposed on a rear-face side of a sound source device.

FIG. 3 is a block diagram illustrating the electric configuration of a sound source device and a pad.

FIG. 4(a) is a schematic diagram schematically illustrating one example of details of a digital pad assignment table, FIG. 4(b) is a schematic diagram schematically illustrating one example of details of a port-tone correspondence table, and FIG. 4(c) is a schematic diagram schematically illustrating one example of details of an analog pad parameter table.

FIG. 5 is a schematic diagram schematically illustrating input ports disposed in a sound source device.

FIG. 6 is a flowchart illustrating a pad assignment process executed by a CPU disposed inside a sound source device.

FIG. 7 is a flowchart illustrating a pad registration process executed by a CPU disposed inside a sound source device.

FIG. 8(a) is a flowchart illustrating a parameter changing process executed by a CPU disposed inside a sound source device, FIG. 8(b) is a flowchart illustrating an analog pad sound generation process executed by a CPU disposed inside a sound source device, and FIG. 8(c) is a flowchart illustrating a tone assignment process executed by a CPU disposed inside a sound source device.

FIG. 9(a) is a flowchart illustrating a request information transmitting process executed by CPU disposed inside first to third pads, FIG. 9(b) is a flowchart illustrating a parameter receiving process executed by the CPU disposed inside the first to third pads, and FIG. 9(c) is a flowchart illustrating a parameter selecting process executed by the CPU disposed inside the first to third pads.

FIG. 10 is a schematic diagram of an electronic drum system including a sound source device according to a further embodiment of the present invention.

FIG. 11 is a schematic diagram of illustrating an electric configuration of a portion of the electronic drum system of FIG. 10.

FIG. 12 is a flowchart illustrating a method performed by processing electronics according to an example embodiment of the present disclosure.

FIG. 13 is a diagram of an instrument signal according to an example embodiment of the of the present disclosure.

FIG. 14 is a flowchart illustrating a method performed by processing electronics according to an example embodiment of the present disclosure.

FIG. 15 is a top-down view of an electronic module according to an embodiment of the present disclosure.

### DETAILED DESCRIPTION

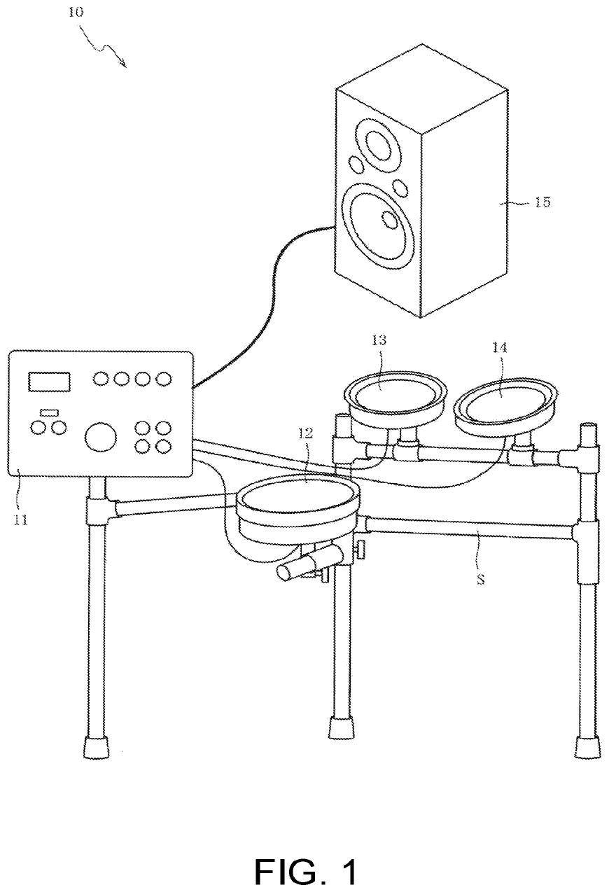

Hereinafter, example embodiments of the present invention will be described with reference to the attached drawings. One example of an electronic musical instrument system 10 is shown in FIG. 1 and includes an electronic drum set or kit having one or more (or a plurality of) electronic pads (three pads are shown in FIG. 1 as pads 12, 13 and 14), where the electronic pads are connected to a sound source device 11 through electrical cables or wires.

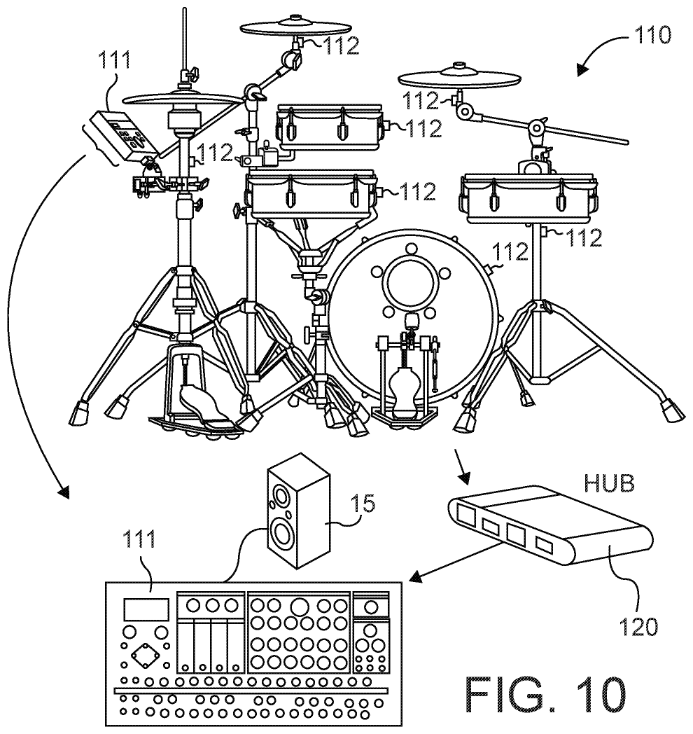

Another example of an electronic musical instrument system 110 is shown in FIG. 10 and includes an electronic drum set or kit having a plurality of electronic pads (four drum pads and three cymbal pads are shown in the electronic drum set or kit in FIG. 10), where each electronic pad has or is connected to a respective wireless communication unit 112. Each wireless communication unit 112 connects for communication with a sound source device 111 through a wireless communication link.

Other examples may include fewer, more or different electronic pads, or different arrangements of electronic pads, than shown in the drawings of FIGS. 1 and 10. Each electronic pad may be an electronic drum pad, an electronic cymbal pad, or another type of electronic percussion device. In other examples, the electronic musical instrument systems 10 and 110 and the electronic pads, may be or include other suitable instruments, other than, or in addition to pads of an electronic drum set.

In the examples of FIGS. 1 and 10, the electronic musical instrument system 10 or 110 include the sound source device 11 or 111 and an amplifier speaker 15. The pads and the sound source device 11 or 111 may be installed on a stand S. The stand S may be a single structure stand as shown in FIG. 1 or may be composed of multiple stand structures as shown in FIG. 10. Further examples may include headphones as an alternative to, or in addition to, the amplifier speaker 15. In the electronic musical instrument systems 10 and 110, a user may beat each of the pads as if playing an acoustic drum or cymbal, and musical sounds with tones or other effects assigned to the pads are generated from the amplifier speaker 15 by performing electric processing using the sound source device 11 or 111.

The sound source device 11 or 111 is a device that has sound source data corresponding to each tone or other effect, and generates a musical sound signal of a musical sound that is generated from the amplifier speaker 15 or from headphones, with a tone or other effect corresponding to a pad in accordance with playing information such as sound generation instruction information received from the pad being beaten.

Each of pads that can be connected to the sound source device 11 or 111 has a respective beating surface and generates playing information on the basis of a vibration of the beating surface that is generated in accordance with a beat on the beating surface. The pads may include different types of pads such as a bass drum, a snare drum, toms, a ride cymbal, a crash cymbal, a hi-hat cymbal, and the like (or any combination or number of those pads).

Here, two types of pads, when roughly classified in accordance with a method of providing playing information, can be connected to the sound source device 11 or 111. One type of pad provides sound generation instruction information of a digital signal from a vibration of a beat for the beating surface as playing information (first playing information) and outputs the sound generation instruction information to the sound source device 11 or 111 through a wire connection terminal on the sound source device 11 or 111, or through a wireless communication connection between the sound source device 111 and a wireless communication unit associated with the pad, as discussed below. Hereinafter, this type of pad will be referred to as a digital connection-type pad.

Another type of pad generates an analog signal representing a vibration level of a beat for a beating surface as playing information (second playing information) and outputs the generated analog signal to the sound source device 11 or 111 through a wire connection terminal on the sound source device 11 or 111. Alternatively, this type of pad may output the generated analog signal to a wireless communication unit associated with the pad, for communication of the playing information through a wireless communication connection between the sound source device 111 and the wireless communication unit, as discussed below. Hereinafter, this type of pad will be referred to as an analog connection-type pad.

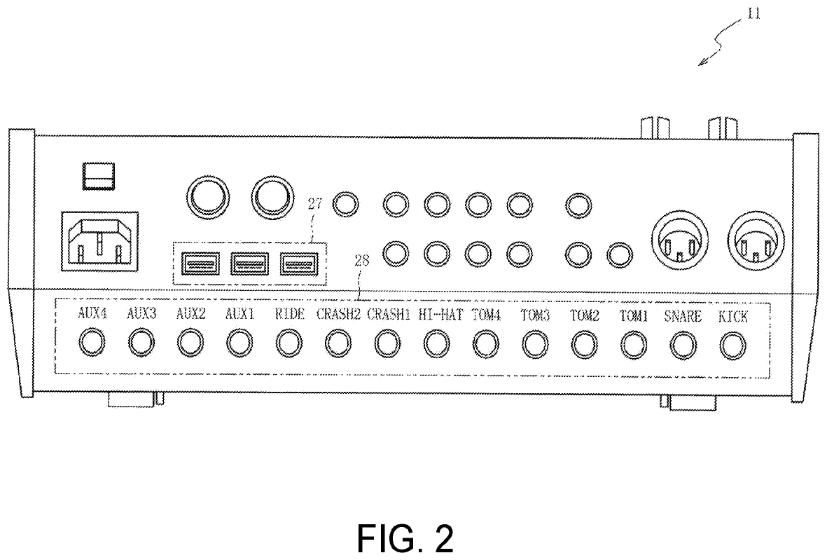

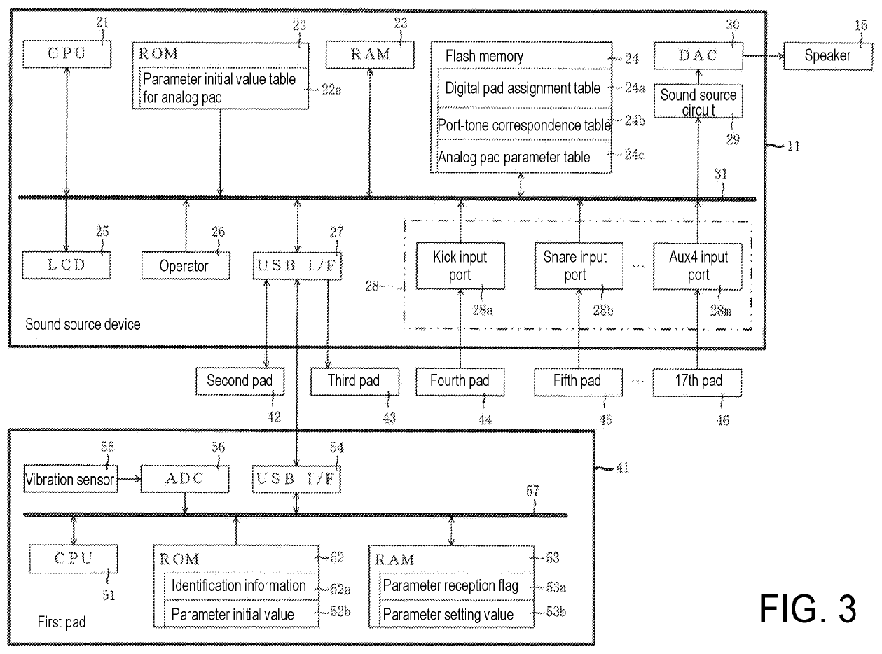

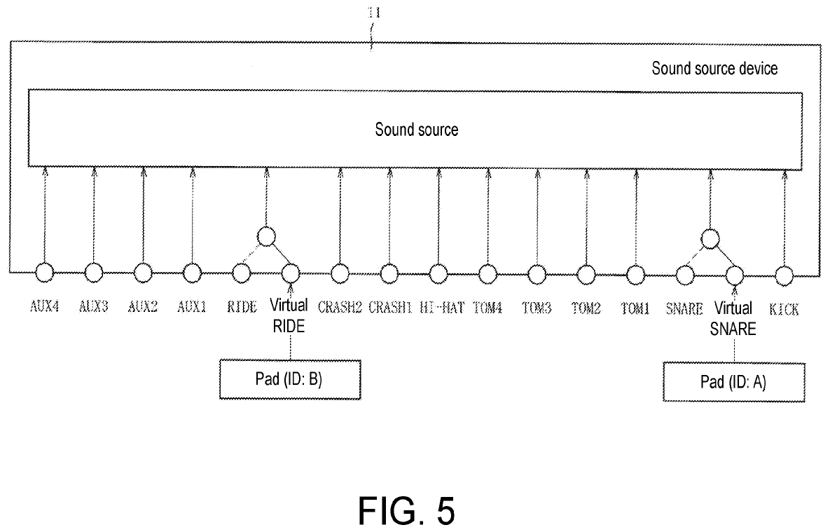

In the example in FIG. 1, the electronic musical instrument system 10 includes the sound source device 11 connected with the pads 12, 13 and 14 and the amplifier speaker 15. FIG. 2 is a schematic diagram schematically illustrating a rear panel on a rear-face side of the sound source device 11, having connectors or interfaces for cable or wire connections with the pads. As illustrated in FIG. 2, a USB interface (hereinafter, referred to as a “USB I/F”) 27 (see FIG. 3) having three USB connectors that are in compliance with USB (universal serial bus) standards are disposed in a rear panel of the sound source device 11. Accordingly, the sound source device 11 is configured to be able to connect to a maximum of three digital connection-type pads through USB cables. In other examples, the sound source device 11 may have fewer or more than three USB connectors for connecting to a different maximum number of digital connection-type pads. A digital connection-type pad can be connected to an arbitrary USB connector of the sound source device 11 regardless of the type thereof (a type such as a bass drum, a snare drum, or the like). The sound source device 11 assigns a virtual input port corresponding to a type of pad to the digital connection-type pad connected to an arbitrary USB connector and handles the digital connection-type pad as being connected to the assigned virtual input port. In addition, the sound source device 11 assigns a tone or other effect to each virtual input port. When playing information is acquired from a pad to which one virtual input port is assigned, the sound source device 11 generates a musical sound with a tone or other effect that has been assigned to the one virtual input port. Details of a virtual input port will be described later with reference to FIG. 5.

In the rear panel of the sound source device 11, as illustrated in FIG. 2, an input port 28 (see FIG. 3) having one or more ports (connection terminals) used for connection to analog connection-type pads for each type of pad is disposed. More specifically, in the input port 28, fourteen physical ports including a KICK input port used for connection of a bass drum, a SNARE input port used for connection of a snare drum, a TOM1 input port, a TOM2 input port, a TOM3 input port, and a TOM4 input port used for connection of toms, a HI-HAT input port used for connection of a hi-hat cymbal, a CRASH1 input port and a CRASH2 input port used for connection of crash cymbals, a RIDE input port used for connection of a ride cymbal, and an AUX1 input port, an AUX2 input port, an AUX3 input port, and an AUX4 input port used for connection of other types of pads are provided.

In the sound source device 11, a corresponding tone or other effect is assigned to each port of the input port 28. The assignment of a tone or other effect can be changed by a user operating the sound source device 11. In a case in which a pad is connected to one port, a musical sound having a tone or other effect assigned to the port is generated. For example, a tone used for a bass drum is assigned to the KICK input port. On the basis of playing information acquired from a pad connected to the KICK input port, the sound source device 11 generates a musical sound having a tone used for a bass drum assigned to the KICK input port. In a case in which a tone of a musical sound generated on the basis of a pad connected to the KICK input port needs to be changed, it is necessary to change the port connecting the pad from the KICK input port to another port or for a user to change a tone assigned to the KICK input port to another tone by operating the sound source device 11.

An example of an electrical configuration of the sound source device 11 and each of pads (a first pad 41 and the like) connected to the sound source device 11 is described with reference to FIG. 3. FIG. 3 is a block diagram illustrating an example of an electrical configuration of the sound source device 11 and each pad.

A first pad 41 is a digital connection-type pad. A second pad 42 and a third pad 43 may have the same configuration as that of the first pad 41, and thus, description thereof will be omitted here.

The first pad 41 includes a central processing unit (CPU) 51, a read only memory (ROM) 52, a random access memory (RAM) 53, a USB I/F 54, a vibration sensor 55, and an analog-to-digital converter (hereinafter, referred to as an “ADC”) 56. Output sides of the CPU 51, the ROM 52, the RAM 53, the USB I/F 54, and the ADC 56 are interconnected through a bus line 57. An input side of the ADC 56 is connected to the vibration sensor 55.

The CPU 51 is a device that performs various control operations and arithmetic operations on the basis of a program and fixed-value data stored in the ROM 52, information stored in the RAM 53, and the like. The ROM 52 is a non-rewritable nonvolatile memory used for storing a program executed by the CPU 51 and fixed-value data. The RAM 53 is a rewritable volatile memory used for temporarily storing information used for arithmetic operations performed by the CPU 51 and information of results of arithmetic operations.

In the ROM 52, at least identification information 52a and parameter initial values 52b are stored as fixed-value data.

The identification information 52a is information used for identifying a pad and includes individual information that is a unique identification (ID) of a pad individually assigned to each pad, model information representing a model number of the pad, and type information representing a type (a bass drum, a snare drum, or the like) of the pad. This identification information 52a is stored in the ROM 52 at the time of manufacturing the first pad 41 and can be incorporated into the first pad 41.

The identification information 52a is transmitted to the sound source device 11 (and the sound source device 11 receives the identification information 52a) in response to a request from the sound source device 11. The sound source device 11 performs assignment of a virtual input port to this pad, management of the assigned virtual input port, and the like using this identification information 52a.

In addition, this identification information 52a may be included in a descriptor that is information used for realizing Plug&Play of the USB standards. In such a case, in response to a request for a descriptor transmitted from the sound source device 11 to the first pad 41 in a case in which connection of the first pad 41 is detected by the sound source device 11, the first pad 41 transmits a descriptor to the sound source device 11, and the identification information 52a is included in the descriptor. The sound source device 11 extracts the identification information 52a from this descriptor and performs assignment of a virtual input port to the first pad 41, management of the assigned virtual input port, and the like.

On the other hand, the identification information 52a may be stored in the ROM 52 additionally to the descriptor. In such a case, after acquiring a descriptor of the first pad 41 that has been requested to be transmitted on the basis of detection of connection of the first pad 41 and setting up communication with the first pad 41, the sound source device 11 may individually transmit a request for transmitting the identification information 52a to the first pad 41. In such a case, the first pad 41 transmits the identification information 52a to the sound source device 11 on the basis of a request for transmission of the individual identification information 52a. Hereinafter, in this embodiment, a case in which the identification information 52a is stored in the ROM 52 in addition to a descriptor will be described as an example.

The parameter initial values 52b are initial values of parameters relating to an operation of the first pad 41. As these parameters, for example, there are various parameters such as a position adjust (PA) that is a parameter for adjusting a change in the tone or other effect for a beat position on a beating surface, a cross stick detect sense (XDS) that is a parameter for adjusting easiness in appearance of a cross stick playing method, a choke sense (CS) that is a parameter for adjusting a sensitivity of a choke playing method, a bell gain (BG) that is a parameter for adjusting an intensity of a beat on a bell and balance of magnitudes of sounds in a bell shot playing method, and the like. Initial values of parameters required in accordance with characteristics of pads among them are stored in the ROM 52 as parameter initial values 52b.

The parameter initial values 52b are transmitted to the sound source device 11 in response to a request from the sound source device 11. In the sound source device 11, values of parameters relating to operations of connected pads are configured to be changed by a user. In a case in which a value of a parameter relating to an operation of a digital connection-type pad is changed by the sound source device 11, the sound source device 11 transmits the parameter after change to a pad using the changed parameter. When a parameter after change is received from the sound source device 11, thereafter, the digital connection-type pad operates using the received parameter after change. In this way, the sound source device 11 is enabled to change parameters relating to an operation of a digital connection-type pad, and the change can be reflected in the digital connection-type pad. In a state in which parameters after change have not been received from the sound source device 11, the digital connection-type pad operates using the parameter initial values 52b.

Subsequently, the RAM 53 is configured to store at least a parameter reception flag 53a and parameter setting values 53b. The parameter reception flag 53a is a flag indicating that the first pad 41 has received parameters after change from the sound source device 11. The parameter setting values 53b are values of parameters after change that have been received from the sound source device 11.

In a case in which the value of the parameter reception flag 53a is “1”, it represents that parameters after change have been received from the sound source device 11. In a case in which the value of the parameter reception flag 53a is “0”, it represents that parameters after change have not been received from the sound source device 11. By connecting the first pad 41 to the sound source device 11, in a case in which power is supplied to the first pad 41, the parameter reception flag 53a is initialized to “0” in a starting process using a CPU 51. Then, when parameters after change are received from the sound source device 11, in accordance with the process of the CPU 51, values of the received parameters after change are stored in the RAM 53 as parameter setting values 53b, and the parameter reception flag 53a is set to “1”.

In a case in which the parameter reception flag 53a is “0”, the first pad 41 operates using the parameter initial values 52b. On the other hand, in a case in which the parameter reception flag 53a is “1”, the first pad 41 operates using the parameter setting values 53b.

The USB I/F 54 is an interface that controls communication with other devices in compliance with USB standards. When connected to the sound source device 11 through a USB cable, the first pad 41 can communicate with the sound source device 11 using this USB I/F 54.

The vibration sensor 55 is a sensor that senses a vibration of the beating surface of the first pad 41 and outputs an analog signal representing a vibration level thereof. The ADC 56 is a converter that converts an analog signal output from the vibration sensor 55 into a digital signal. The CPU 51 determines a vibration level of the beating surface of the first pad 41 output from the ADC 56 and generates sound generation instruction information used for causing the sound source device 11 to generate a musical sound on the basis of the vibration level. The sound source device 11 generates a musical sound signal on the basis of the sound generation instruction information and generates a musical sound from the built-in amplifier speaker 15.

A fourth pad 44, a fifth pad 45, . . . , a 17-th pad 46 are analog connection-type pads. In such a pad (analog connection-type pad), a vibration sensor not illustrated in the drawing is disposed. A vibration of the beating surface disposed in each pad is detected by the vibration sensor, and an analog signal representing a vibration level thereof is output from each pad. The sound source device 11 receives an analog signal representing this vibration level from an analog connection-type pad connected to the input port 28 and converts the received analog signal into a digital signal using an ADC (not illustrated in the drawing) built into the sound source device 11. The sound source device 11 analyzes the vibration level converted into the digital signal using the CPU 21. Then, the sound source device 11 generates a musical sound signal on the basis of the vibration level and generates a musical sound from the built-in amplifier speaker 15.

Here, as described above, corresponding tones or other effects are assigned to each of the input ports 28a to 28m of the sound source device 11. The tones of the fourth pad 44, the fifth pad 45, . . . , the 17-th pad 46 are tones or other effects that are assigned to the connected input ports 28a to 28m. In other words, in the case of being connected to the KICK input port 28a, the fourth pad 44 generates a musical sound with a tone assigned to the KICK input port 28a. In the case of being connected to the SNARE input port 28b, the fifth pad 45 generates a musical sound with a tone assigned to the SNARE input port 28b. In addition, in the case of being connected to the AUX4 input port 28m, the 17-th pad 46 generates a musical sound with a tone assigned to the AUX4 input port 28m.

Next, the sound source device 11 will be described. The sound source device 11 includes a CPU 21, a ROM 22, a RAM 23, a flash memory 24, a liquid crystal display (LCD) 25, an operator 26, a USB I/F 27 (see FIG. 2), an input port 28 (see FIG. 2), a sound source circuit 29, and a digital-to-analog converter (hereinafter, referred to as a “DAC”) 30. The CPU 21, the ROM 22, the RAM 23, the flash memory 24, the LCD 25, the operator 26, the USB I/F 27, the input port 28, and the sound source circuit 29 are interconnected through a bus line 31. In addition, the sound source circuit 29 is connected to an input side of the DAC 30, and the built-in amplifier speaker 15 is connected to an output side of the DAC 30.

The CPU 21 is a device that performs various control operations and arithmetic operations on the basis of a program and fixed-value data stored in the ROM 22, information stored in the RAM 23, and the like. The ROM 22 is a non-rewritable nonvolatile memory used for storing a program executed by the CPU 21 and fixed-value data. The RAM 23 is a rewritable volatile memory used for temporarily storing various kinds of data and the like when various control operations and arithmetic operations performed by the CPU 21 are executed.

In the ROM 22, at least a parameter initial value table 22a for an analog pad is stored. The parameter initial value table 22a for an analog pad is a table that represents initial values of parameters relating to operation of pads for each model for all the analog connection-type pads planned to be connected to the sound source device 11.

In a case in which one analog connection-type pad is connected to the input port 28 of the sound source device 11, a user needs to set parameters required for operating the pad in the sound source device 11. However, inputting of the parameters one by one increases a user's burden. The user selects a model of a connected analog connection-type pad among models of analog connection-type pads registered in the sound source device 11 in advance. Accordingly, initial values of parameters corresponding to the model are read from the parameter initial value table 22a for an analog pad, and the initial values are set as parameters relating to an operation of the analog connection-type pad. Thus, the user can easily set parameters relating to the operation of the analog connection-type pad.

The flash memory 24 is a rewritable nonvolatile memory used for storing information used for arithmetic operations of the CPU 21. In other words, information stored in the flash memory 24 can be rewritten and can be maintained also for a period in which the power of the sound source device 11 is off. In the flash memory 24, at least a digital pad assignment table 24a, a port-tone correspondence table 24b, and an analog pad parameter table 24c are stored.

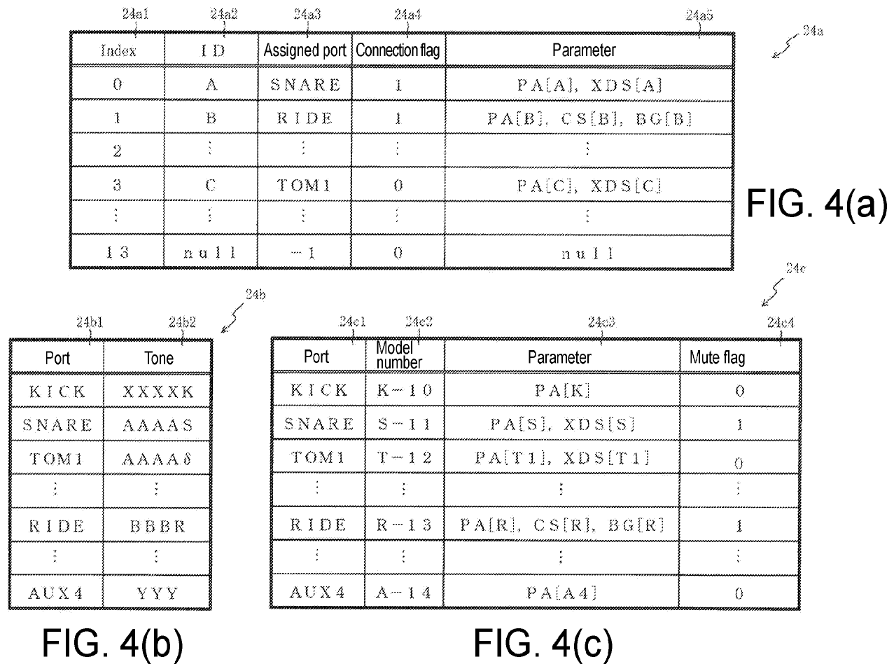

First, details of the digital pad assignment table 24a will be described with reference to FIG. 4(a). FIG. 4(a) is a schematic diagram schematically illustrating one example of details of the digital pad assignment table 24a. This digital pad assignment table 24a is a table that is used for storing virtual input ports, which will be described later, assigned to digital connection-type pads (for example, the first pad 41 to the third pad 43) connected through the USB I/F 27 in a maximum of 14 digital connection-type pads.

The digital pad assignment table 24a is composed of an index area 24a1, an ID area 24a2, an assignment port area 24a3, a connection flag area 24a4, and a parameter area 24a5. The index area 24al is an area in which an index number is stored. The index number is a number used for identifying one element (digital connection-type pad) in an array that is provided for storing virtual input ports assigned to a maximum of 14 digital connection-type pads for each digital connection type pad.

Integers acquired by sequential increase of one each time from 0 to 13 are stored as index numbers in the index area 24al in advance in a manufacturing stage of the sound source device 11 and, thereafter, continue to be maintained without being rewritten. The sound source device 11 stores and manages virtual input ports assigned to a maximum of 14 digital connection-type pads using these index numbers.

The ID area 24a2 is an area in which individual information used for identifying a digital connection-type pad that is stored in association with an index number stored in the index area 24al is stored. As the individual information stored in the ID area 24a2, individual information included in identification information 52a acquired from a digital connection-type pad in a case in which the digital connection-type pad is connected is used. As described above, this individual information is a unique ID of a pad that is individually assigned to each pad. Accordingly, a digital connection-type pad stored in association with an index number can be identified from the individual information stored in the ID area 24a2.

The assignment port area 24a3 is an area that is used for storing a virtual input port assigned to a digital connection-type pad stored in association with an index number of the index area 24a1. Here, a virtual input port will be described with reference to FIG. 5. FIG. 5 is a schematic diagram schematically illustrating input ports disposed in the sound source device 11.

As described above with reference to FIG. 2, in the sound source device 11, as input ports 28 used for connecting analog connection-type pads, 14 physical input ports KICK, SNARE, TOM1, TOM2, TOM3, TOM4, HI-HAT, CRASH1, CRASH2, RIDE, AUX1, AUX2, AUX3, and AUX4 are provided.

On the other hand, in the sound source device 11, three USB connector are provided as connection terminals used for connecting digital connection-type pads. At this time, a digital connection-type pad can be connected to an arbitrary USB connector regardless of a type of the pad (a type such as a bass drum, a snare drum, or the like).

Here, in this sound source device 11, a concept of a virtual input port is introduced. More specifically, the sound source device 11 introduces 14 virtual input ports to which digital connection-type pads are connected in accordance with 14 physical input ports to which analog connection-type pads are connected. In other words, as virtual input ports, a virtual KICK, a virtual SNARE, a virtual TOM1, a virtual TOM2, a virtual TOM3, a virtual TOM4, a virtual HI-HAT, a virtual CRASH1, a virtual CRASH2, a virtual RIDE, a virtual AUX1, a virtual AUX2, a virtual AUX3, and a virtual AUX4 are provided.

The same tone or other effect as that of a corresponding physical input port is assigned to each virtual input port. For example, the same tone as that of a physical KICK input port is assigned to a virtual KICK input port, and the same tone as that of a physical SNARE input port is assigned to a virtual SNARE input port.

When detecting that a digital connection-type pad is connected, the sound source device 11 acquires the identification information 52a from the digital connection-type pad. On the basis of the model information (information representing a model number) and the type information (information representing a type of pad such as a bass drum, a snare drum, or the like) included in the identification information 52a, a virtual input port that is appropriate for the type of the digital connection-type pad is assigned.

For example, in a case in which a digital connection-type pad of which individual information (ID) is “A” is a snare drum, a virtual SNARE input port is assigned to the pad (ID: A). In addition, in a case in which a digital connection-type pad of which individual information (ID) is “B” is a ride cymbal, a virtual RIDE input port is assigned to the pad (ID: B).

Accordingly, a digital connection-type pad connected to the sound source device 11 is in a state of virtually being connected to a virtual input port of that type. Then, the sound source device 11 can generate a musical sound signal with a tone or other effect assigned to the virtual input port on the basis of playing information output from the digital connection-type pad. In other words, a tone or other effect according to a type of pad can be assigned to and associated with the digital connection-type pad (or other digital connection-type playing operation device).

In this way, the sound source device 11 assigns a virtual input port to a digital connection-type pad instead of directly assigning a tone or other effect thereto. Here, a conventional sound source device corresponding to only an analog connection-type pad generates a sound based on the analog connection-type pad with a tone or other effect assigned to an input port to which the analog connection-type pad is connected. The sound source device 11 also assigns a virtual input port to a digital connection-type pad and generates a sound with a tone or other effect assigned to the virtual input port. Accordingly, the sound source device 11 can increase a degree of freedom of tone or other effect setting for a connected digital connection-type pad and can perform assignment of a tone or other effect such that it can be easily understood by a user.

In addition, in a case in which one digital connection-type pad is virtually connected to one virtual input port, the sound source device 11 does not assign another digital connection-type pad to that one virtual input port. Accordingly, even in a case in which another digital connection-type pad of the same type as that of one digital connection-type pad is connected to the sound source device 11, a virtual input port connected to one digital connection-type pad being assigned to another digital connection-type pad can be avoided. Accordingly, the same tone or effect as that of one digital connection-type pad being assigned to another digital connection-type pad can be inhibited.

On the other hand, in a case in which another digital connection-type pad of the same type as that of one digital connection-type pad is connected to the sound source device 11, the sound source device 11 assigns a virtual input port desired by a user among virtual input ports to which no pad is connected to the another digital connection-type pad. At this time, the sound source device 11 displays a screen prompting a user to input a desired virtual input port on the LCD 25. A user can set a virtual input port assigned to the another digital connection-type pad by operating the operator 26. In this way, in a case in which another digital connection-type pad of the same type as that of one digital connection-type pad is connected to the sound source device 11, an input port set by a user can be assigned to the another digital connection-type pad. Accordingly, a musical sound having a tone or other effect desired by a user can be generated using the another digital connection-type pad.

In addition, in a case in which a digital connection-type pad is in the state of being virtually connected to a virtual input port, even when an analog connection-type pad is connected to a physical input port corresponding to the virtual input port, this sound source device 11 is configured to cause the generation of a musical sound based on the analog connection-type pad to be mute. For example, in a case in which a digital connection-type pad is virtually connected to a virtual SNARE input port, even when the fifth pad 45 is connected to the SNARE input port 28b (see FIG. 2), generation of a musical sound based on the fifth pad 45 becomes mute. Accordingly, in a case in which a digital connection-type pad and an analog connection-type pad of the same type are connected to the sound source device 11, the digital connection-type pad generates a musical sound with priority. Accordingly, a musical sound having the same tone or effect being generated in the digital connection-type pad and the analog connection-type pad can be inhibited.

Referring back to FIG. 4(a), the description of the assignment port area 24a3 will be continued. When a virtual input port is assigned to a connected digital connection-type pad, the sound source device 11 stores individual information of the digital connection-type pad in the ID area 24a2 in association with a predetermined index number of the index area 24al and stores assignment port identification information identifying an assigned virtual input port in the assignment port area 24a3.

More specifically, in a case in which there are index numbers for which the assignment port identification information has not been registered, a smallest index number among the unregistered index numbers is identified. Then, for the identified index number, individual information of the digital connection-type pad and assignment port identification information identifying an assigned virtual input port are stored. In this way, assignment port identification information for a maximum of 14 digital connection-type pads can be stored in the digital pad assignment table 24a. In addition, practically, 14 digital connection-type pads are not connected for a short period. Accordingly, assignment port identification information for a digital connection-type pad being immediately overwritten by assignment port identification information for another digital connection-type pad can be inhibited. Accordingly, the assignment port identification information can be maintained for a long period.

In addition, in a manufacturing stage, “null” information is written in the ID area 24a2 in association with all the index numbers. In addition, information representing “−1” is written in the assignment port area 24a3 in association with all the index numbers. Accordingly, the sound source device 11 can determine an index number for which “null” information is stored in the ID area 24a2, and information representing “−1” is stored in the assignment port area 24a3 to be an index number for which information of assignment of a virtual input port has not been registered.

On the other hand, in a case in which there is no index number for which the assignment port identification information has not been registered, a smallest index number among index numbers for which assignment port identification information of digital connection-type pads that are not connected at that time point is identified. Then, for the identified index number, individual information of the digital connection-type pad and assignment port identification information identifying an assigned virtual input port are stored. In this way, even when assignment port identification information for 14 digital connection-type pads is stored in the digital pad assignment table 24a, assignment port identification information for a digital connection-type pad that is connected at the time point is maintained. In addition, the number of digital connection-type pads that can be connected to the sound source device 11 is a maximum of three as described above, and accordingly, necessarily, there is an index number for which assignment port identification information of a digital connection-type pad that is not connected at the time point is stored.

Here, since the digital pad assignment table 24a is a table stored in the flash memory 24, the digital pad assignment table 24a continues to be maintained in the digital pad assignment table 24a also for a period in which the power of the sound source device 11 is off. Accordingly, in a case in which a virtual input port is assigned temporarily to one digital connection-type pad connected to the sound source device 11, as long as the assignment port identification information continues to be maintained in the digital pad assignment table 24a without the assignment port identification information being overwritten, when the power of the sound source device 11 is on, the same virtual input port can be assigned to the one digital connection-type pad on the basis of the assignment port identification information stored in the digital pad assignment table 24a.

In addition, even when the one digital connection-type pad is detached from the sound source device 11 once, in a case in which the one digital connection-type pad is connected to the sound source device 11 again, the assignment port identification information for the one digital connection-type pad is maintained in the digital pad assignment table 24a, and accordingly, the same virtual input port can be assigned on the basis of the assignment port identification information.

In this way, a digital-type pad to which a virtual input port was assigned by being connected to the sound source device 11 in the past can be caused to generate a musical sound with the same tone or other effect as that at the time of being connected to the sound source device 11 in the past as the assignment port identification information thereof continues to be maintained in the digital pad assignment table 24a. Accordingly, the digital connection-type pad can be used without causing a user to have a feeling of strangeness.

The connection flag area 24a4 is an area used for storing a connection flag. The connection flag is a flag that represents whether a digital connection-type pad of which information is stored in association with the index number of the index area 24al is connected to the sound source device 11. In a case in which the value of the connection flag is “1”, it represents that a digital connection-type pad stored with an index number associated with the connection flag is connected to the sound source device 11. In addition, in a case in which the value of the connection flag is “0”, it represents that a digital connection-type pad stored with an index number associated with the connection flag is not connected to the sound source device 11.

In a case in which the power of the sound source device 11 is on, “0” is written in the connection flag area 24a4 for connection flags associated with all the index numbers temporarily. Thereafter, when connection of a digital connection-type pad is detected, a connection flag of a connection flag area 24a4 associated with an index number for which information of the digital connection-type pad is stored is set to “1”. When it is detected that a digital connection-type pad that has been connected is not connected, the connection flag of a connection flag area 24a4 associated with an index number for which information of the digital connection-type pad is stored is cleared to “0”.

By checking connection flags stored in this connection flag area 24a4, the sound source device 11 can determine an index number in which information relating to a digital connection-type pad not connected at that time point is stored.

The parameter area 24a5 is an area that stores parameters relating to an operation of a digital connection-type pad stored in association with an index number of the index area 24a1. In a manufacturing stage, “null” information is written in the parameter area 24a5 in association with all the index numbers.

In a case in which a digital connection-type pad is connected, when information relating to the digital connection-type pad is not stored in the digital pad assignment table 24a, the sound source device 11 acquires parameter initial values 52b stored in the digital connection-type pad. Then, assignment port identification information of the digital connection-type pad is stored in association with a predetermined index number, and the acquired parameter initial values 52b are stored in association with the same index number.

In the sound source device 11, parameters relating to an operation of the digital connection-type pad stored in the digital pad assignment table 24a are displayed on the LCD 25, and values of the parameters can be changed by a user operating the operator 26. When the values of the parameters are changed by the user, the sound source device 11 overwrites the parameters before change stored in the parameter area 24a5 of the digital pad assignment table 24a with the parameters after change for storage. In addition, the sound source device 11 transmits the parameters after change to the digital connection-type pad of which the parameters have been changed. In this way, a user can change the parameters relating to an operation of the digital connection-type pad through the sound source device 11 and can operate the digital connection-type pad on the basis of the changed parameters.

Here, as described above, the digital pad assignment table 24a continues to be maintained also for a period in which the power of the sound source device 11 is off. In this way, when parameters relating to an operation of a digital connection-type pad connected to the sound source device 11 are stored in the digital pad assignment table 24a, the parameters continue to be maintained also for a period in which the power of the sound source device 11 is off unless the parameters are overwritten with parameters of another digital connection-type pad. Even in a case in which the parameters are changed by a user, the parameters after change continue to be maintained in the digital pad assignment table 24a.

Thus, in a case in which connection of a digital connection-type pad is detected, the sound source device 11 checks whether or not information of the digital connection-type pad is stored in the digital pad assignment table 24a. Then, in a case in which the information is stored, parameters of the digital connection-type pad stored in the parameter area 24a5 of the digital pad assignment table 24a are transmitted to the digital connection-type pad. In this way, the sound source device 11 can operate a connected digital connection-type pad with the parameters set for the digital connection-type pad in the past reflected. Accordingly, a user resetting the parameters of the digital connection-type pad again can be inhibited, and accordingly, a burden on the user can be relieved.

Meanwhile, the digital pad assignment table 24a may be regarded as storing information (assigned port identification information, parameters, and the like) relating to a pad in association with individual information (ID) of the pad for each digital connection-type pad that has been connected temporarily to the sound source device 11. The digital pad assignment table 24a is stored in the flash memory 24 and thus continues to be maintained also for a period in which the power of the sound source device 11 is off. Accordingly, in a case in which a digital connection-type pad that has been connected to the sound source device 11 temporarily is connected to the sound source device 11 again, even when the power is off for a period in which the pad is detached, as long as the information relating to the pad continues to be stored in the digital pad assignment table 24a, the digital connection-type pad can be operated on the basis of the information.

In addition, the information relating to a digital connection-type pad stored in the digital pad assignment table 24a is not limited to the assigned port identification information and the parameters and may be arbitrary as long as the information is information relating to an operation of the pad. For example, information used for identifying a tone or other effect (in this embodiment, a tone or other effect assigned to an assigned virtual input port) output by the pad may be stored in the digital pad assignment table 24a in association with the individual information of the pad.

Next, details of the port-tone correspondence table 24b will be described with reference to FIG. 4(b). FIG. 4(b) is a schematic diagram schematically illustrating one example of details of the port-tone correspondence table 24b. This port-tone correspondence table 24b is a table that is used for assigning tones or other effects to 14 physical input ports 28a to 28m and 14 virtual input ports.

The port-tone correspondence table 24b is composed of a port area 24b1 and a tone area 24b2. The port area 24b1 is an area that defines types of ports (port types) of the physical input ports 28a to 28m and the virtual input ports, and the types are classified into 14 types including KICK, SNARE, TOM1, TOM2, TOM3, TOM4, HI-HAT, CRASH1, CRASH2, RIDE, AUX1, AUX2, AUX3, and AUX4.

14 kinds of port types defined in this port area 24b1 are commonly used by the physical input ports 28a to 28m and the virtual input ports. For example, “KICK” of the port area 24b1 is commonly used by the physical KICK input port 28a and a virtual KICK that is a virtual input port. “SNARE” of the port area 24b1 is commonly used by the physical SNARE input port 28b and a virtual SNARE that is a virtual input port. In other words, the same sound source is assigned to a physical input port and a virtual input port of which port types are the same.

In addition, port types defined in this port area 24b1 are written in a manufacturing stage of the sound source device 11 and thereafter continue to be maintained without being rewritten.

The tone area 24b2 is an area that, in association with each port type defined in the port area 24b1, defines a tone or other effect assigned to a port type. The sound source device 11 is configured to assign one tone in sound source data of tones of a plurality of kinds stored in the sound source circuit 29 for each port type. In the tone area 24b2, information representing the assigned tone is stored in association with a port type defined in the port area 24b1.

In the tone area 24b2 of this port-tone correspondence table 24b, in a manufacturing stage of the sound source device 11, information representing a predetermined tone or other effect respectively are stored in association with each port type defined in the port area 24b1. In addition, in the sound source device 11, a tone or other effect assigned to each port type is configured to be able to be changed by a user. By operating the operator 26 while viewing a screen displayed on the LCD 25, a user can set one tone or other effect assigned to each port type in sound source data of tones or effects of a plurality of kinds stored in the sound source circuit 29. When one tone or other effect is assigned to one port type by a user, information of a tone or other effect of the tone area 24b2 corresponding to one port type is rewritten with information representing one tone or other effect assigned by the user.

When playing information is acquired from each pad connected to the sound source device 11, the sound source device 11 generates a musical sound on the basis of the playing information. At this time, the sound source device 11 identifies a tone or other effect assigned to a port type of a physical input port or a virtual input port to which the pad is connected from the port-tone correspondence table 24b and generates a musical sound signal corresponding to the tone or other effect.

For example, in the example illustrated in FIG. 4(b), in a case in which a musical sound is generated on the basis of playing information from a pad that is virtually connected to the virtual SNARE, the sound source device 11 identifies a tone “AAAAS” associated with the port type “SNARE” from the port-tone correspondence table 24b and generates a musical sound signal having the tone “AAAAS”. In addition, in a case in which a musical sound is generated on the basis of playing information from a pad connected to a physical AUX4 input port 28m, the sound source device 11 generates a musical sound signal having a tone “YYY” that is associated with the port type “AUX4”.

As described above, this port-tone correspondence table 24b is stored in the flash memory 24 and continues to be maintained also for a period in which the power is off. Accordingly, in a case in which a tone or other effect assigned to one port type is changed by a user, even when the power is off and is turned on again thereafter, the pad connected to the port type can generate a sound with the tone or other effect changed by the user.

Thereafter, details of the analog pad parameter table 24c will be described with reference to FIG. 4(c). FIG. 4(c) is a schematic diagram schematically illustrating one example of details of the analog pad parameter table 24c. The analog pad parameter table 24c is a table that is used for storing parameters relating to an operation of an analog connection-type pad connected to a physical input port 28.

This analog pad parameter table 24c is composed of a port area 24cl, a model number area 24c2, a parameter area 24c3, and a mute flag area 24c4. In the port area 24cl, port types of physical input ports 28 to which analog connection-type pads may be connected are defined similarly to the port area 24b1 of the port-tone correspondence table 24b illustrated in FIG. 4(b). The port types defined in this port area 24cl are written in a manufacturing stage of the sound source device 11 and thereafter, continue to be maintained without being rewritten.

The model number area 24c2 is an area that stores a model number of an analog connection-type pad input to be connected to an input port of the port type by a user is stored in association with each port type defined in the port area 24cl. The parameter area 24c3 is an area that stores parameters relating to an operation of an analog connection-type pad having a model number connected to the input port 28 of a port type in association with each port type defined in the port area 24cl. In a manufacturing stage of the sound source device 11, in the analog pad parameter table 24c, for each port type defined in the port area 24cl, a model number of a pad having a high possibility of being connected to the input port 28 of the port type is written in the model number area 24c2 as an initial value, and initial values of the parameters relating to an operation of a pad having the model number are written in the parameter area 24c3.

In a case in which a user connects an analog connection-type pad having a model number different from the model numbers defined in the model number area 24c2 to the input port 28 of a certain port type, parameters relating to an operation of the connected analog connection-type pad are set by operating the operator 26. More specifically, a user selects a port type of the input port 28 of which setting of parameters needs to be changed and then inputs a model number of a connected pad to the sound source device 11. Accordingly, the sound source device 11 reads initial values of parameters relating to an operation of the pad, which are stored in advance for the pad having the model number, from the parameter initial value table 22a for an analog pad. Then, the sound source device 11 stores the read initial values of the parameters relating to the operation of the pad in the parameter area 24c3 in association with the port type of the input port 28 selected by the user.

In addition, the sound source device 11 may be configured such that parameters relating to an operation of a connected pad can be manually set by a user for the port type of the input port 28 selected by the user.

The parameters stored in the parameter area 24c3 are configured to be able to be changed by a user. In other words, a user operates the operator 26 while viewing the screen displayed on the LCD 25, thereby changing parameters relating to an operation of a connected pad for the port type of the input port 28 that has been selected. The parameters after change are stored in the parameter area 24c3 by overwriting the parameters before change associated with the port type of the input port 28 of which the parameters have been changed with the parameters after change.

The mute flag area 24c4 is an area that stores a mute flag in association with each port type defined in the port area 24cl. The mute flag is a flag representing that generation of a musical sound based on the analog connection-type pad connected to the input port 28 of a corresponding port type is in the state of being mute. As described above, in a case in which a digital connection-type pad is in the state of virtually being connected to a virtual input port, the sound source device 11 causes the generation of a musical sound based on an analog connection-type pad connected to a physical input port corresponding to the virtual input port to be mute. In a case in which the value of the mute flag is “1”, it represents that an analog connection-type pad connected to the input port 28 of a port type associated with the mute flag is in the state of being mute. In addition, in a case in which the value of the mute flag is “0”, it represents that an analog connection-type pad connected to the input port 28 of a port type associated with the mute flag is in the state of being non-mute.

In a case in which the power of the sound source device 11 becomes on, “0” is written in the mute flag area 24c4 in association with all the port types once. Thereafter, when connection of a digital connection-type pad is detected, and a virtual input port is assigned to the digital connection-type pad, “1” is stored in the mute flag area 24c4 in association with the same port type as the port type of the assigned virtual input port. Accordingly, generation of a musical sound becomes mute for an analog connection-type pad connected to a physical input port 28 of the same port type as that of the virtual input port to which the digital connection-type pad is virtually connected.

On the other hand, when it is detected that the digital connection-type pad that has been connected to the sound source device 11 becomes non-connected, the sound source device 11 stores “0” in the mute flag area 24c4 in association with the same port type as that of a virtual input port assigned to the digital connection-type pad that becomes non-connected. Accordingly, the mute state is released for the analog connection-type pad connected to the physical input port 28 of the same port type as that of the virtual input port to which the digital connection-type pad that becomes non-connected is virtually connected.

The sound source device 11 determines whether or not a mute state is set for an analog connection-type pad connected to the physical input port 28 by referring to the mute flag stored in the mute flag area 24c4. Then, in a case in which the analog connection-type pad is set to a mute state, playing information from the analog connection-type pad is ignored, and a musical sound signal is not generated.

On the other hand, in a case in which the analog connection-type pad is in a non-mute state, the sound source device 11 reads parameters (parameters associated with each port type of an input port to which the analog connection-type pad is connected in the analog pad parameter table 24c) relating to an operation of the analog connection-type pad from the parameter area 24c3. The sound source device 11 determines a generation timing of a musical sound, an intensity (velocity) of the sound generation, and the like while analyzing the playing information (vibration level) acquired from the analog connection-type pad in accordance with the parameters. Then, the sound source device 11 generates a musical sound signal with a tone or other effect of the input port 28, to which the analog connection-type pad is connected, which is assigned using the port-tone correspondence table 24b.

Referring back to FIG. 3, the description will be continued. The LCD 25 is a liquid crystal display device that displays a screen representing the state of the sound source device 11 and a screen for settings of the sound source device 11. The operator 26 is a switch group that is used by a user for operating the sound source device 11.

The sound source circuit 29 is a circuit, in which various kinds of sound source data are stored, generating a digital signal having a tone or effect and a volume instructed to be generated for the sound source circuit 29 from the CPU 21 using the sound source data. The DAC 30 is a conversion device that converts a digital signal output from the sound source circuit 29 into an analog sound signal. The built-in amplifier speaker 15 is a device that generates a sound by amplifying a sound signal transmitted from the DAC 30 and converting the sound signal into a physical vibration. In other words, on the basis of a sound generation instruction from the CPU 21, a sound having a tone or effect and a volume represented in the sound generation instruction is generated from the built-in amplifier speaker 15.

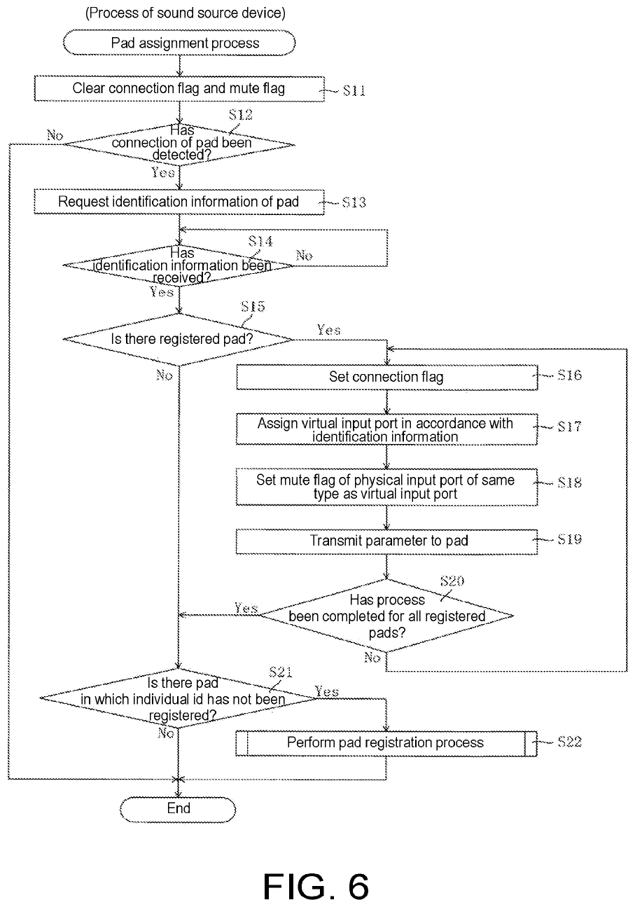

Thereafter, a pad assignment process executed by the CPU 21 of the sound source device 11 will be described with reference to FIG. 6. FIG. 6 is a flowchart illustrating the pad assignment process. This pad assignment process is a process for assigning a virtual input port to a digital connection-type pad connected to the sound source device 11. This pad assignment process is necessarily executed after the power of the sound source device 11 is on. In addition, this pad assignment process is executed also in a case in which connection of the digital connection-type pad is detected during the operation of the sound source device 11.

In the pad assignment process, first, all connection flags stored in the connection flag area 24a4 of the digital pad assignment table 24a and all the mute flags stored in the mute flag area 24c4 of the analog pad parameter table 24c are cleared to “0” (S11). Thereafter, it is determined whether or not connection of a digital connection-type pad has been detected in the USB connector of the USB I/F 27 (S12). Then, in a case in which connection of a pad is not detected (S12: No), this process ends. On the other hand, in a case in which connection of a pad is detected in the process of S12 (S12: Yes), the process proceeds to the process of S13. All the pads that are detected in the process of S12 are pads that are targets for assignment of virtual input ports (hereinafter, referred to as “assignment target pads”) in this process.

In addition, the processes of S11 and S12 are processes performed only in a case in which a pad assignment process is executed first after the power of the sound source device 11 becomes on. In a case in which a pad assignment process is executed on the basis of detection of connection of a digital connection-type pad during the operation of the sound source device 11, the processes of S11 and S12 are skipped, and the process starts from S13. In this case, a pad of which connection has been detected is an assignment target pad in this process.

In the process of S13, all the assignment target pads are requested to transmit identification information 52a (S13). Then, it is determined whether or not the identification information 52a has been received from all the assignment target pads for the request (S14). In a case in which the identification information 52a has not been received (S14: No), the process of S14 is repeatedly executed, and the process waits until the identification information 52a is received from all the assignment target pads.

In a case in which it is determined that identification information 52a has been received from all the assignment target pads in the process of S14 (S14: Yes), thereafter, it is determined whether or not there is an assignment target pad registered in the digital pad assignment table 24a (S15). More specifically, it is determined whether or not individual information included in the received identification information 52a is stored in the ID area 24a2 of the digital pad assignment table 24a for each assignment target pad.

As a result, in a case in which there is no assignment target pad registered in the digital pad assignment table 24a in advance (S15: No), the process proceeds to the process of S21. On the other hand, in a case in which there are assignment target pads registered in the digital pad assignment table 24a in advance (S15: Yes), processes of S16 to S19 are executed for all the registered assignment target pads.

More specifically, first, in the digital pad assignment table 24a, an index number of the index area 24al (hereinafter, referred to as a “assignment target pad index number”) for which individual information of the assignment target pad is associated with the ID area 24a2 is identified, and the connection flag of the connection flag area 24a4 associated with the assignment target pad index number is set to “1” (S16). In this way, connection of the assignment target pad to the sound source device 11 can be indicated.

Next, assignment port identification information of the assignment port area 24a3 associated with the assignment target pad index number is acquired from the digital pad assignment table 24a, and a virtual input port identified using the assignment port identification information is assigned to the assignment target pad (S17).

Accordingly, in a case in which a virtual input port is assigned to a certain digital connection-type pad in accordance with connection to the sound source device 11 in the past, as long as the assignment port identification information continues to be maintained in the digital pad assignment table 24a, when the power of the sound source device 11 is on or the digital connection-type pad is connected during the operation of the sound source device 11, the same virtual input port as that assigned in the past can be assigned to the digital connection-type pad. Accordingly, such a digital connection-type pad can be caused to generate a musical sound with the same tone or other effect as that at the time of being connected to the sound source device 11 in the past, and accordingly, the digital connection-type pad can be used without causing the user to have a feeling of strangeness.

Next, a process of setting a physical input port 28 of which the port type is the same as that of the virtual input port assigned to the assignment target pad in the process of S17 to be mute is performed (S18). More specifically, in the analog pad parameter table 24c, the mute flag of the mute flag area 24c4 is set to “1” in association with a port type of the physical input port 28 to be set to be mute among port types defined in the port area 24cl. Accordingly, generation of a musical sound becomes mute for an analog connection-type pad connected to a physical input port 28 of the same port type as that of a virtual input port to which a digital connection-type pad is virtually connected.

Next, in the digital pad assignment table 24a, parameters of the parameter area 24a5 associated with the assignment target pad index number (parameters relating to an operation of the assignment target pad) are acquired and are transmitted to the assignment target pad (S19). Accordingly, the assignment target pad operates in accordance with the parameters transmitted in the process of S19.

As described above, when a certain digital connection-type pad is connected to the sound source device 11, parameters relating to an operation of the digital connection-type pad are maintained in the parameter area 24a5 of the digital pad assignment table 24a. When values of the parameters are changed by a user, the parameters after change are maintained in the parameter area 24a5. Accordingly, as long as the parameters of the digital connection-type pad continue to be maintained in the digital pad assignment table 24a, when the power of the sound source device 11 is turned on or when the digital connection-type pad is connected during an operation of the sound source device 11, the digital connection-type pad can be operated with parameters set to the digital connection-type pad in the past reflected. Accordingly, the user resetting the parameters of the digital connection-type pad again can be inhibited, therefore, the burden on the user can be alleviated.

After the process of S19, it is determined whether or not the processes of S16 to S19 have been executed for all the assignment target pads registered in the digital pad assignment table 24a (S20). As a result, in a case in which there is an assignment target pad for which the processes of S16 to S19 have not been executed (S20: No), the process is returned to the process of S16, and the processes of S16 to S19 are executed for the unexecuted assignment target pad. On the other hand, in a case in which it is determined that the processes of S16 to S19 have been executed for all the assignment target pads registered in the digital pad assignment table 24a (S20: Yes), the process proceeds to the process of S21.

In the process of S21, it is determined whether or not there is an assignment target pad that is not registered in the digital pad assignment table 24a (S21). In a case in which there is no unregistered assignment target pad (S21: No), the pad assignment process ends. On the other hand, in a case in which there is an unregistered assignment target pad (S21: Yes), a pad registration process is executed (S22). After execution of the pad registration process (S22), the pad assignment process ends.

The pad registration process of S22 is a process of assigning a virtual input port to an assignment target pad that is not registered in the digital pad assignment table 24a (hereinafter, referred to as a “unregistered assignment target pad”) and storing the assignment port identification information thereof in the digital pad assignment table 24a. In addition, in a case in which there are a plurality of unregistered assignment target pads, assignment of virtual input ports is performed for all the unregistered assignment target pads.

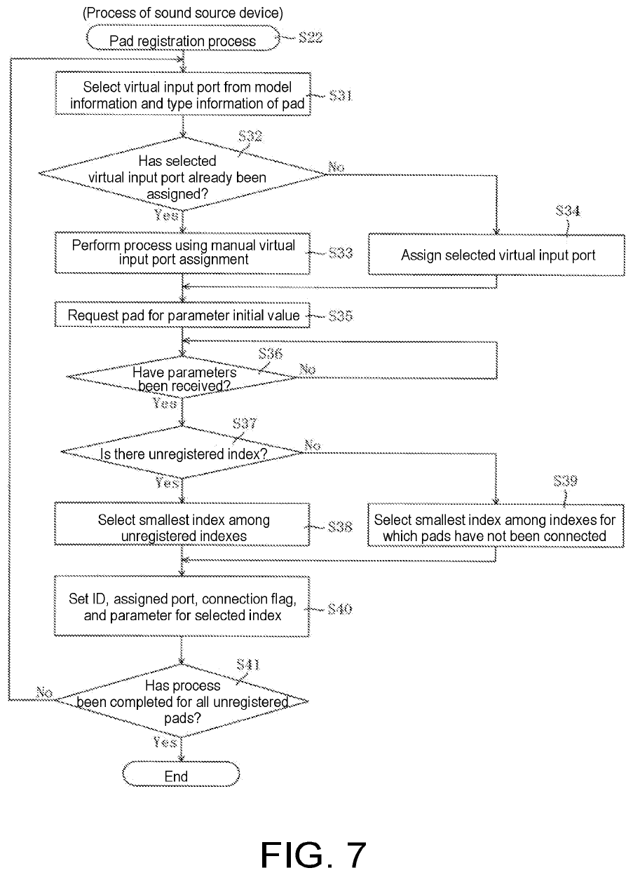

Here, details of the pad registration process (S22) will be described with reference to FIG. 7. FIG. 7 is a flowchart illustrating the pad registration process (S22).

In the pad registration process (S22), first, in the process of S14 of the pad assignment process (FIG. 6), a model number and a pad type (a bass drum, a snare drum, or the like) of the unregistered assignment target pad are determined on the basis of model information and type information included in the identification information 52a received from the unregistered assignment target pad, and a virtual input port that is appropriate for the unregistered assignment target pad is selected in accordance with the determination (S31). Here, in a case in which there are a plurality of unregistered assignment target pads, the process of S31 is performed for one unregistered assignment target pad among unregistered assignment target pads for which assignment of a virtual input port has not been executed.

Next, it is determined whether or not the virtual input port that has been selected in the process of S31 has already been assigned to another digital connection-type pad (S32). More specifically, the assignment port identification information stored in the assignment port area 24a3 of the digital pad assignment table 24a and the connection flag stored in the connection flag area 24a4 are referred to. Then, it is determined whether or not there is a pad to which the virtual input port selected in the process of S31 has been assigned among pads of which connection flags are set to “1” (pads which are connected to the sound source device 11 and to which virtual input ports have been assigned), whereby the determination of S32 is performed.

In a case in which it is determined that the virtual input port selected in the process of S31 has not been assigned to another digital connection-type pad in the process of S32 (S32: No), the selected virtual input port is assigned to an unregistered assignment target pad (S34), and the process proceeds to the process of S35.

On the other hand, in a case in which it is determined that the virtual input port selected in the process of S31 has already been assigned to another digital connection-type pad in the process of S32 (S32: No), a process in which a virtual input port that is manually selected by a user is assigned to the unregistered assignment target pad is executed (S33), and the process proceeds to the process of S35.

More specifically, first, the assignment port identification information stored in the assignment port area 24a3 of the digital pad assignment table 24a and the connection flag stored in the connection flag area 24a4 are referred to. Next, a digital connection-type pad which is connected to the sound source device 11 at that time point and to which a virtual input port has been assigned is identified, and a port type of the input port that has been assigned is determined. Next, the port types of the virtual input ports to which a digital connection-type pad has not been assigned is presented to the user by displaying the port types on the LCD 25, and the user is prompted to select a port type to be assigned to the unregistered assignment target pad among the presented port types. Then, a virtual input port of the port type selected by the user by operating the operator 26 is assigned to the unregistered assignment target pad.

Accordingly, in a case in which another digital connection-type pad of the same type as one digital connection-type pad is connected to the sound source device 11, a virtual input port selected by the user can be assigned to the another digital connection-type pad. At this time, the sound source device 11 causes the user to select the virtual input port assigned to the another digital connection-type pad among virtual input ports that have not been assigned. Accordingly, the same tone or other effect as a tone or other effect generated by one digital connection-type pad being generated by another digital connection-type pad can be inhibited. In addition, a musical sound of a tone or other effect desired by the user can be generated from the another digital connection-type pad.

In the process of S35, an unregistered assignment target pad is requested to transmit parameter initial values 52b relating to an operation of the unregistered assignment target pad (S35). Then, it is determined whether the parameter initial values 52b have been received from the unregistered assignment target pad in response to the request (S36), and the process of S36 is repeatedly executed while the parameter initial values 52b are not received (S36: No). Accordingly, the process stands by until the parameter initial values 52b are received from the unregistered assignment target pad.

On the other hand, in a case in which it is determined that the parameter initial values 52b have been received from the unregistered assignment target pad (S36: Yes) in the process of S36 (S36: Yes), next, it is determined whether or not there is an index number for which the assignment port identification information is not registered in the digital pad assignment table 24a (S37). As a result, in a case in which it is determined that that there are index numbers for which assignment port identification information has not been registered (S37: Yes), a smallest index number is selected among index numbers for which assignment port identification information has not been registered in the digital pad assignment table 24a (S38), and the process proceeds to the process of S40.

On the other hand, in a case in which it is determined that there is no index number for which assignment port identification information has not been registered in the digital pad assignment table 24a in the process of S37 (S37: No), a smallest index number is selected among index numbers for which assignment port identification information of digital connection-type pads that are not connected at that time point is stored by referring to the connection flag area 24a4 of the digital pad assignment table 24a (S39), and the process proceeds to the process of S40.

Then, for the digital pad assignment table 24a, individual information of an unregistered assignment target pad (individual information included in the identification information 52a received from an unregistered assignment target pad in the process of S14 of the pad assignment process (FIG. 6)) is stored in the ID area 24a2 in association with an index number selected in the process of S38 or S39, assignment port identification information identifying a virtual input port assigned in the process of S33 or S34 is stored in the assignment port area 24a3, the connection flag of the connection flag area 24a4 is set to “1”, and the parameter initial values 52b of which reception has been checked in the process of S36 is stored in the parameter area 24a5 (S40). Then, the process proceeds to the process of S41.

In a case in which there are index numbers for which the assignment port identification information has not been registered, assignment port identification information and the like of an unregistered assignment target pad are stored for a smallest index number among unregistered index numbers. Accordingly, until assignment port identification information is stored for a maximum of 14 digital connection-type pads, the assignment port identification information can be maintained in the digital pad assignment table 24a. In addition, practically, there is no case in which 14 digital connection-type pads are connected in a short period, and accordingly, assignment port identification information for digital connection-type pads can be maintained for a long period.

In addition, in a case in which there is no index number for which assignment port identification information has not been registered, for a smallest index number among index numbers for which assignment port identification information of digital connection-type pads that are not connected at that time point is stored, assignment port identification information and the like of unregistered assignment target pads are stored. Accordingly, although assignment port identification information for 14 digital connection-type pads is stored in the digital pad assignment table 24a, assignment port identification information for digital connection-type pads that are connected at the time point can be maintained.

In the process of S41, it is determined whether or not the processes of S31 to S40 have been executed for all the unregistered assignment target pads (S41). As a result, in a case in which there is an unregistered assignment target pad for which the processes of S31 to S40 have not been executed (S41: No), the process is returned to the process of S31, and the processes of S31 to S40 are executed for the unregistered assignment target pad for which the processes have not been executed. On the other hand, in a case in which the processes of S31 to S40 have been executed for all the unregistered assignment target pads (S41: Yes), the pad registration process ends.

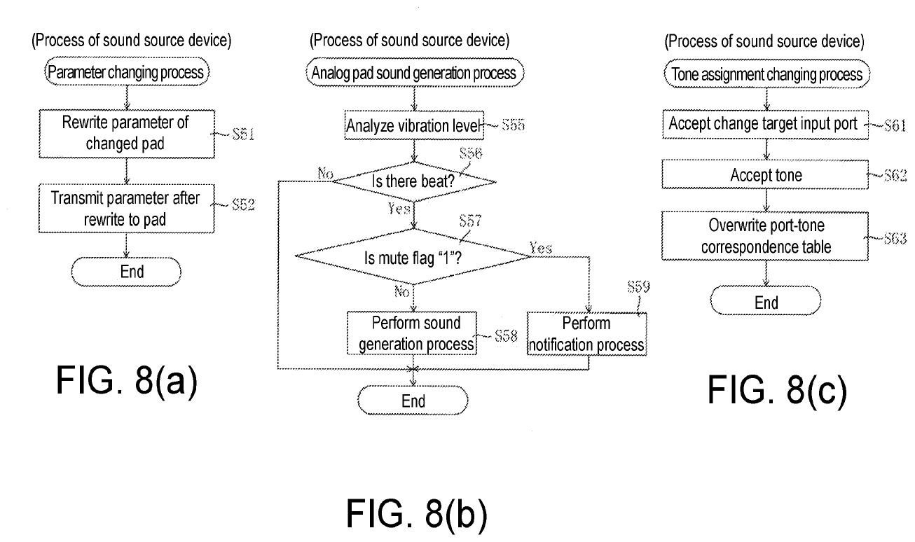

Next, details of the parameter changing process executed by the CPU 21 disposed inside the sound source device 11 will be described with reference to FIG. 8(a). FIG. 8(a) is a flowchart illustrating the parameter changing process. The parameter changing process is a process for executing a process relating to a change in a case in which parameters relating to an operation of a digital connection-type pad connected to the sound source device 11 are changed by a user. This process is executed in a case in which there is an input of change of the parameters from the user.

In the parameter changing process, first, for a digital connection-type pad of which parameters have been changed, the parameters are rewritten (S51). More specifically, in the digital pad assignment table 24a, parameters of the parameter area 24a5 corresponding to an index number in which individual information of a digital connection-type pad of which parameters have been changed is stored in the ID area 24a2 are overwritten with parameters after change. Accordingly, the parameters after change are maintained in the sound source device 11.

Next, the parameters after change are transmitted to the digital connection-type pad of which the parameters have been changed (S52), and the parameter changing process ends. In this way, a user can change parameters relating to an operation of a digital connection-type pad through the sound source device 11, and the digital connection-type pad can be operated on the basis of the changed parameters.

Next, details of the analog pad sound generation process executed by the CPU 21 disposed inside the sound source device 11 will be described with reference to FIG. 8(b). FIG. 8(b) is a flowchart illustrating the analog pad sound generation process. The analog pad power generation process is a process of controlling sound generation of an analog connection-type pad connected to the sound source device 11. The analog pad sound generation process is repeatedly executed for every predetermined time while the sound source device 11 is on.

In the analog pad sound generation process, first, while referring to parameters defined in each input port in the parameter area 24c3 of the analog pad parameter table 24c, a vibration level signal acquired as playing information from an analog connection-type pad for each input port is analyzed (S55). As a result of the analysis, it is determined whether or not there has been a beat for the pad (S56). As a result, in a case in which it is determined that there has been no beat (S56: No), the analog pad sound generation process ends.

On the other hand, in a case in which it is determined that there has been a beat for the pad (S56: Yes), next, it is determined whether or not a mute flag of a physical input port 28 to which the analog connection-type pad for which there has been the beat is connected is set to “1” among mute flags of physical input ports 28 defined in the mute flag area 24c4 by referring to the analog pad parameter table 24c (S57).

Then, when the mute flag is not set to “1” (S57: No), a sound generation process for the beat is executed (S58), and this process ends. On the other hand, when the mute flag is set to “1” (S57: Yes), the process of S59 is executed instead of the process of S58, and this process ends.

In the process of S59, a notification used for notifying a user that a physical input port to which the beaten analog connection-type pad is connected is set to a mute state is performed. As a notification method thereof, an arbitrary method such as displaying of a message informing an indication thereof on the LCD 25 of the sound source device 11, changing of a color of a backlight of the LCD 25 from a color of a normal time for a predetermined time, generating of a warning sound with a tone or other effect different from a tone or other effect assigned to each pad (for example, a beep sound), or the like may be used.

As described above, in this sound source device 11, in the case of a state in which a digital connection-type pad is virtually connected to a virtual input port, a physical input port corresponding to the virtual input port is set to a mute state (a mute flag is set to “1”). In this case, even when an analog connection-type pad is connected to the physical input port and the pad is beaten, the process of S58 is set to be non-executed, and accordingly, generation of a musical sound based on the pad can be caused to be mute. Accordingly, in a case in which a digital connection-type pad and an analog connection-type pad of the same type are connected to the sound source device 11, a musical sound is generated by the digital connection-type pad with priority, and musical sounds of the same tone or other effect being generated by the digital connection-type pad and the analog connection-type pad can be inhibited.

In addition, in this case, when the analog connection-type pad is beaten, a notification is performed by the process of S59. Accordingly, a user can perceive a state in which a digital connection-type pad and an analog connection-type pad of the same type are connected to the sound source device 11, and the digital connection-type pad generates a musical sound with priority. In addition, in this embodiment, although a notification is performed in a case in which a physical input port to which a beaten analog connection-type pad is connected is set to a mute state, the notification may be configured not to be performed.

Next, details of the tone assignment changing process executed by the CPU 21 disposed inside the sound source device 11 will be described with reference to FIG. 8(c). FIG. 8(c) is a flowchart illustrating the tone assignment changing process. The tone assignment changing process is a process for executing a process relating to a change in a case in which the change of a tone or other effect assigned to each input port in accordance with the port-tone correspondence table 24b is performed by a user. This process is executed in a case in which an input of change of the assignment of tones or other effects is performed by the user.

In the tone assignment changing process, first, a port type of an input port that is a change target, which has been input by a user, is accepted (S61). Next, a tone or other effect after change input by the user is accepted (S62). Then, information of the tone or other effect of the tone area 24b2 associated with each port type accepted in the process of S64 is overwritten with information representing tones or other effects accepted in S65 in the port-tone correspondence table 24b (S63), and the tone assignment changing process ends.

Accordingly, in a case in which a tone or other effect assigned to each input port is changed by a user, information of tones or other effects after change can be stored in the port-tone correspondence table 24b. The port-tone correspondence table 24b is stored in the flash memory 24. Accordingly, in a case in which a tone or other effect assigned to one port type is changed by a user, even when the power is off and then is turned on again thereafter, a pad connected to the port type can generate a sound with the tone or other effect changed by the user.

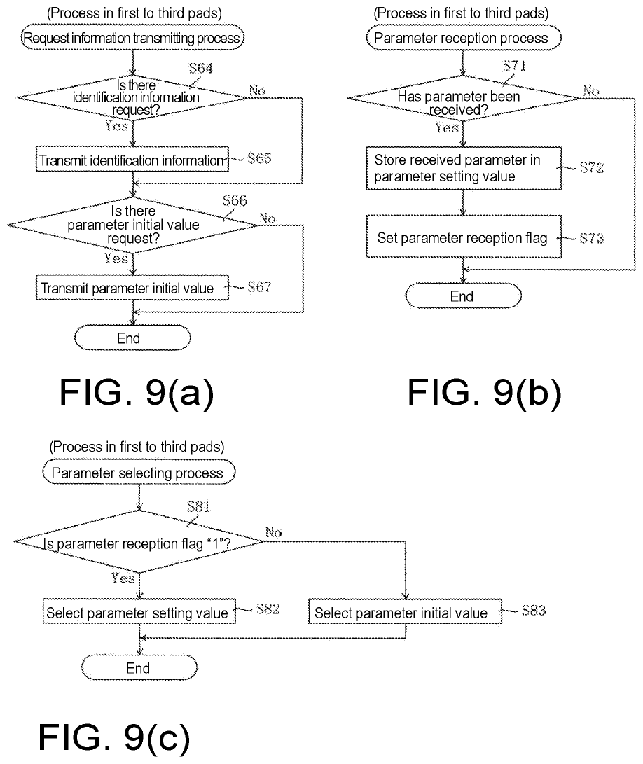

Next, a request information transmitting process executed by the CPU 51 inside digital connection-type pads (first to third pads 41 to 43) will be described with reference to FIG. 9(a). FIG. 9(a) is a flowchart illustrating the request information transmitting process. This request information transmitting process is a process for transmitting information requested from the sound source device 11 and is repeatedly executed for every predetermined time by the CPU 51.

In the request information transmitting process, first, it is determined whether there is a request for transmission of the identification information 52a from the sound source device 11 (S64). In a case in which there is a request for transmission of the identification information 52a (S64: Yes), the identification information 52a is read from the ROM 52 and is transmitted to the sound source device 11 (S65), and the process proceeds to the process of S66. The identification information 52a transmitted in the process of S65 is used by the sound source device 11 for performing assignment of a tone or other effect to this pad, management of the assigned tone or other effect, and the like.

As a result of the process of S64, in a case in which there is no request for transmission of the identification information 52a (S64: No), the process of S65 is skipped, and the process proceeds to the process of S66. In the process of S66, it is determined whether there is a request for transmission of the parameter initial values 52b from the sound source device 11 (S66). As a result thereof, when there is a request for transmission of the parameter initial values 52b (S66: Yes), the parameter initial values 52b are read from the ROM 52 and are transmitted to the sound source device 11 (S67), and this process ends. In the process of S67, the sound source device 11 can manage parameters relating to an operation of this pad, and the sound source device 11 may enable a user to change the parameters.

As a result of the process of S66, when there is no request for transmission of the parameter initial values 52b (S66: No), the process of S67 is skipped, and this process ends.

Next, a parameter receiving process executed by the CPU 51 disposed inside digital connection-type pads (first to third pads 41 to 43) will be described with reference to FIG. 9(b). FIG. 9(b) is a flowchart illustrating the parameter receiving process. This parameter receiving process is a process for receiving transmitted parameters after change in a case in which the parameters relating to an operation of this pad, which have been changed in the sound source device 11 by a user (see S51 illustrated in FIG. 8(a)), are transmitted from the sound source device 11 (see S52 illustrated in FIG. 8(a)). The parameter receiving process is repeatedly executed by the CPU 51 for every predetermined time.

In the parameter receiving process, first, it is determined whether or not parameters after change transmitted in the process of S52 illustrated in FIG. 8(a) from the sound source device 11 have been received (S71). As a result thereof, in a case in which the parameters after change have not been received (S71: No), the parameter receiving process ends.

On the other hand, as a result of the process of S71, in a case in which the parameters after change have been received (S71: Yes), first, the received parameters after change are stored in the RAM 53 as parameter setting values 53b (S72), the parameter reception flag 53a is set to “1” (S73), and the parameter receiving process ends.

Accordingly, the parameters changed by the user in the sound source device 11 can be reflected in the operation of this pad.

Next, a parameter selecting process executed by the CPU 51 disposed inside digital connection-type pads (first to third pads 41 to 43) will be described with reference to FIG. 9(c). FIG. 9(c) is a flowchart illustrating the parameter selecting process. The parameter selecting process is a process for selecting parameters used by this pad and is executed when the CPU 51 reads parameters required for an operation of this pad.

In the parameter selecting process, first, it is determined whether or not the parameter reception flag 53a is “1” (S81). As a result thereof, in a case in which the parameter reception flag 53a is “1” (S81: Yes), the parameter setting values 53b stored in the RAM 53 are selected (S82), and the parameter selecting process ends. Accordingly, this pad can be operated using the parameters changed by the user in the sound source device 11 which are received in the parameter receiving process (see FIG. 9(b)).

On the other hand, as a result of the process of S81, in a case in which the parameter reception flag 53a is not “1” (S81: No), the parameter initial values 52b stored in the ROM 52 are selected (S83), and the parameter selecting process ends. Accordingly, in a case in which parameters are not changed by a user in the sound source device 11, and parameters are not received from the sound source device 11, this pad can be operated using the parameter initial values 52b stored in the ROM 52.

As described above, according to the sound source device 11 of this embodiment, in addition to a physical USB connector disposed in the USB I/F 27, a virtual input port is provided for each pad type of digital connection-type pad. A tone or other effect generated on the basis of playing information input to the virtual input port is assigned to the virtual input port using the port-tone correspondence table 24b. Then, when it is detected that a digital connection-type pad is connected to the USB connector of the sound source device 11, identification information 52a including individual information, model information, and type information is acquired by the sound source device 11 from the connected digital connection-type pad.

Then, a virtual input port that is appropriate for a digital connection-type pad is assigned to the digital connection-type pad of which connection with the USB connector of the sound source device 11 has been detected on the basis of the model information and the type information included in the acquired identification information 52a. When playing information is acquired from the digital connection-type pad connected to the USB connector, a musical sound signal of a tone or other effect assigned in the port-tone correspondence table 24b is generated for a virtual input port assigned to the digital connection-type pad on the basis of the playing information. In this way, the degree of freedom of setting of a tone or other effect to a digital connection-type pad connected to the sound source device 11 can be increased, and the assignment of a tone or other effect can be performed with the same sense as that of the case of an analog connection-type pad and can be performed such that is can be easily understood by the user.

On the other hand, in a case in which a virtual input port corresponding to model information and type information of the identification information 52a acquired from a digital connection-type pad is in a state of being assigned to another digital connection-type pad, the assignment of the virtual input port to the digital connection-type pad of which connection with the USB connector has been detected is configured not to be executed. Accordingly, generation of musical sounds using the same tone or effect in a case in which a digital connection-type pad of the same type as that of a digital connection-type pad that has already been connected is connected can be inhibited.

In addition, in a case in which a virtual input port corresponding to each type of digital connection-type pad of which connection with one USB connector has been detected is determined to be in the state of being assigned to another digital connection-type pad, assignment of one virtual input port among virtual input ports not assigned to the connected digital connection-type pad can be accepted from a user. Then, the one virtual input port accepted from the user is assigned to the digital connection-type pad of which connection with one USB connector has been detected. Accordingly, in a case in which a digital connection-type pad of the same type as that of a digital connection-type pad that has already been connected is connected to the sound source device 11, a musical sound can be generated using a different tone or effect set by the user.

In addition, in a case in which it is detected that a digital connection-type pad has been connected to the USB connector, parameters relating to an operation of the digital connection-type pad are acquired from the connected digital connection-type pad. The parameters are stored in the digital pad assignment table 24a in association with individual information of the digital connection-type pad. These parameters are maintained also for a period in which the power is off.

Then, in a case in which change of the parameters stored in this digital pad assignment table 24a is performed by the user, parameters after change are transmitted to the digital connection-type pad of the parameters. In this way, change of parameters relating to an operation of a digital connection-type pad can be performed using the sound source device 11, and the change can be reflected in the digital connection-type pad.

In addition, in a case in which it is detected that a digital connection-type pad has been connected to one USB connector, in a case in which it is determined that assignment port identification information and parameters are stored in association with individual information of the digital connection-type pad, parameters stored in the digital pad assignment table 24a are transmitted to the digital connection-type pad. Accordingly, in a case in which the digital connection-type pad of which parameters have been changed in the sound source device 11 is connected to the sound source device 11 again, the digital connection-type pad can be operated using the changed parameters.

As above, while the present invention has been described on the basis of the embodiments, the present invention is not limited to the embodiments described above at all, and it can be easily assumed that various changes and modifications can be performed within a range not departing from the concept of the present invention. For example, each embodiment may be configured by changing the embodiment by adding a part or a plurality of parts of components included in other embodiments to the embodiment, replacing a part or a plurality of parts of the components of the embodiment with a part or a plurality of parts of the components of other embodiments, or the like including modified examples to be described below. In addition, numerical values taken in the embodiments described above are one example, and it is natural to employ different numerical values.

For example, in the embodiment described above, although a case in which three USB connectors are disposed in the USB interface 27 has been described, the number of USB connectors may be an arbitrary number. In addition, although a case in which the digital pad assignment table 24a stores information such as virtual input ports assigned to a maximum of 14 digital connection-type pads has been described, the number of digital connection-type pads that can be stored in the digital pad assignment table 24a may be an arbitrary number. In addition, it is preferable that the number of digital connection-type pads that can be stored in the digital pad assignment table 24a should be equal to or larger than the number of USB connectors disposed in the USB interface 27.

In the embodiment described above, a case in which the identification information 52a including model information and type information is stored in the digital connection-type pad, and the sound source device 11 selects a virtual input port that is appropriate for this digital connection-type pad on the basis of the model information and the type information included in the identification information 52a acquired from the digital connection-type pad has been described. In contrast to this, the sound source device 11 may select a virtual input port that is appropriate for the digital connection-type pad by using any one of the model information and the type information. In a case in which the type information of the digital connection-type pad is known, an appropriate virtual input port can be determined using only the type information. In addition, by storing information of a virtual input port that is appropriate for a model in advance in the ROM 22 of the sound source device 11 for each model of the digital connection-type pad, a virtual input port that is appropriate for the digital connection-type pad can be determined using only the model information of the digital connection-type pad. In addition, in accordance with this modified example, in the digital connection-type pad, information included in the identification information 52a may be limited to any one of the model information and the type information.

In addition, in the identification information 52a of the digital connection-type pad, in addition to the model information and the type information or instead of the model information and the type information, information representing a type of input port that is appropriate for the digital connection-type pad may be included, and the sound source device 11 may select a virtual input port that is appropriate for the digital connection-type pad on the basis of the information representing a type of input port that is appropriate for the digital connection-type pad included in the identification information 52a acquired from the digital connection-type pad.

In the embodiment described above, in the pad assignment process executed by the CPU 21 disposed inside the sound source device 11, in a case in which there is an assignment target pad registered in the digital pad assignment table 24a in advance (S15: Yes), a case in which a virtual input port identified using the assignment port identification information of the digital pad assignment table 24a is assigned (S17) has been described. Here, in the process of S15, in a case in which there are a plurality of assignment target pads registered in the digital pad assignment table 24a, it may be determined whether or not there is a duplicate between virtual input ports identified using the assignment port identification information of the digital pad assignment table 24a in each assignment target pad, and, in a case in which there is a duplicate, a virtual input port that is manually selected by the user may be assigned to at least one of the assignment target pads. More specifically, similar to the process of S33 of the pad registration process (see FIG. 7), a port type of a virtual input port to which a digital connection-type pad has not been assigned at that time point is presented to a user by displaying the port type on the LCD 25, and the user is prompted to select a port type to be assigned among the presented port types. Then, a virtual input port of a port type that is selected by a user by operating the operator 26 is assigned to the assignment target pad. In this way, assignment of the same virtual input port to different pads can be inhibited. In addition, assignment port identification information used for identifying the port type selected by the user here may be stored through overwriting in the assignment port area 24a3 of the digital pad assignment table 24a in association with an index number with which the assignment target pad is associated. In this way, thereafter, a virtual input port of a port type selected by the user can be assigned to the assignment target pad.

In the embodiment described above, in a case in which assignment port identification information for one digital connection-type pad is registered in the assignment port area 24a3 of the digital pad assignment table 24a, a virtual input port identified using the assignment port identification information may be arbitrarily changed to another virtual input port by the user. Then, assignment port identification information used for identifying a virtual input port after change may be stored in the assignment port area 24a3 through overwriting in association with an index number in which information of the one digital connection-type pad is stored. Accordingly, a virtual input port assigned to the digital connection-type pad in accordance with connection to the sound source device 11 can be freely changed by a user.

In the example embodiment shown in FIG. 1, the pads of the electronic musical instrument system 10 are connected to a sound source device 11 through a plurality of electrical cables or wires. In another example of an electronic musical instrument system 110 as shown in FIG. 10, each of the pads of the electronic musical instrument includes or is connected to a respective wireless communication unit 112 that provides a wireless communication connection to the sound source device 111. Thus, in the example in FIG. 10, wireless communication connections are provided between the pads and the sound source device 111 instead of multiple cables or wire connections of the type shown in FIG. 1. In certain examples, the sound source device 111 may include both cable or wire connection terminals as shown on the sound source device 11 in FIG. 2, and also wireless communication connection capabilities as described herein in regard to FIG. 10.

The electronic musical instrument system 110 in FIG. 10 includes an electronic drum set or kit having one or more electronic pads as described above, a wireless communication hub 120 and a sound source device 111. Other embodiments may include or connect with other types of electronic musical instruments. In some examples, the sound source device 111 corresponds to the sound source device 11 described herein, but connects to the wireless communication hub 120 through a cable or wire connection, such as, but not limited to a connection through one of the USB terminals of the sound source device described above. In other examples, the sound source device 111 may operate similar to the sound source device 11 described herein, but includes the wireless communication hub 120 (e.g., electronics of the hub 120) internally, as part of the sound source device 111 (e.g., within the same component housing as the rest of the components of the sound source device 111). In yet other examples, the sound source device 111 need not include some or all of the input ports (connection terminals) used for connection to analog connection-type pads or for both analog and digital connection-type pads as described above in regard to sound source device 11 and, instead, may rely on wireless communication connections with the pads (or other instruments) of the electronic musical instrument system 110.

In the example of FIG. 10, each pad of the electronic drum set or kit includes or is connected to a wireless communication unit 112 having an electronic module 200 (described below) configured for wireless communication with the sound source device 111, through the hub 120. In other examples, one or more of the pads of the drum set or kit are connected to the sound source device 111 through wire or cable connections, as discussed above in regard to the sound source device 11. More specifically, instrument signals produced by the one or more pads of the drum set or kit in response to actuations of the pads, may be transmitted, wirelessly, from the wireless communication units 112 associated with the pads to the hub 120. The hub 120 can include one or more electronic processors (such as, but not limited to microprocessors) and/or circuits configured to provide operations and functions described herein, and can serve as an intermediary device for receiving the instrument signals. In some, but not all examples, those electronic processors and/or circuits of the hub 120 may include a corresponding electronic module 200 (discussed below) but configured for wireless communication with the electronic modules associated with the one or more pads. As discussed above, the hub 120 may be connected to or is included in the sound source device 111 that produces sound signals for one or more amplifier speakers 15, headphones or other sound producing devices. The transmission link from the hub 120 to the sound source device 111 may be wired in order to minimize latency. In other examples, the transmission link from the hub 120 to the sound source device 111 is a wireless link (e.g., using a different protocol, frequency, timing, code, or other mechanism to be distinguished from wireless transmissions from the one or more pads of the electronic musical instrument system 110. The hub 120 can be provided with or receive electrical power via one or more batteries in or associated with the hub, a connection to a wall socket, a connection to a host device, or other means known in the art.

In certain embodiments described herein, messages or signals (used interchangeably herein) can be sent from the pads of the electronic musical instrument system 110 to the hub 120 using various specifications known in the art, such as the Bluetooth LE, though it is understood that other formats may be used. In one embodiment, the signals can be sent using a frequency-shift keying (FSK) frequency module action scheme. One specific embodiment uses Bluetooth and/or 1 Mbps FSK. It is understood that any signal-sending specification with adequate latency performance could be used in embodiments of the present disclosure.

While certain prior plug-in (i.e., wired) modules have typically experienced latency in the range of 4-12 ms, embodiments of the present disclosure can experience latencies of 20 ms or under, 15 ms or under, 12 ms or under, 10 ms or under, 8 ms or under, 6 ms or under, or even lower latency. Moreover, the additional latency caused by the wireless nature of certain embodiments versus a wired equivalent, if any, can be less than 1 ms, less than 500 μs, less than 250 μs, even less, or zero; or the wireless nature may actually reduce overall system latency versus a wired equivalent.

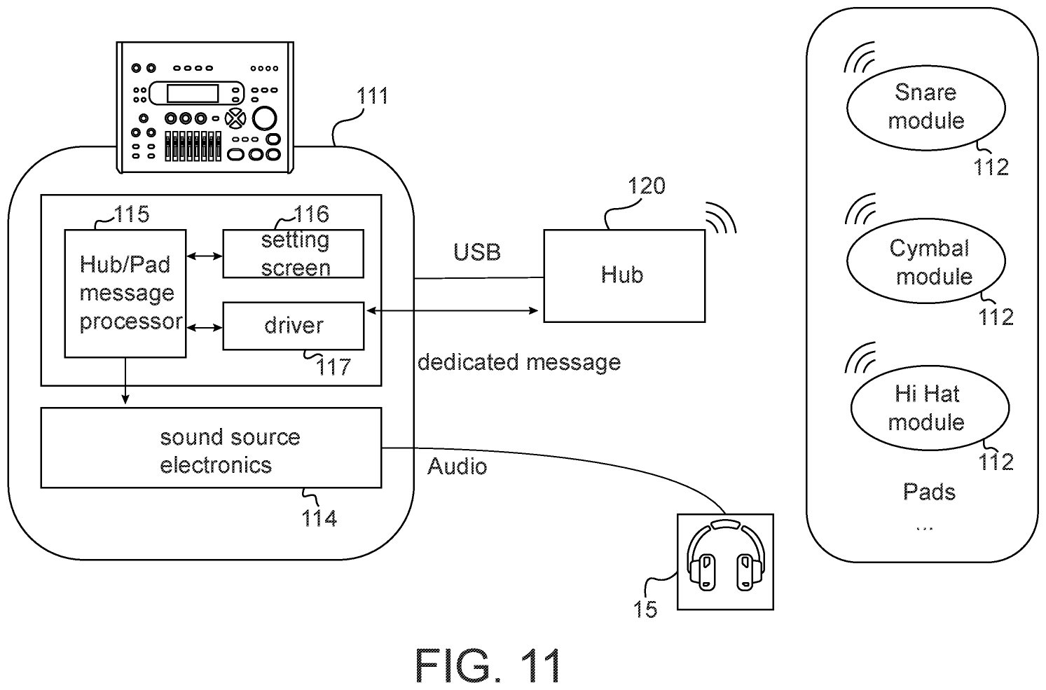

A generalized electrical diagram of an example of a portion of the electronic musical instrument system 110 is shown in FIG. 11. The diagram in FIG. 11 shows the hub 120 as being connected to the sound source device 111 by a wire or cable connection, for example, through a USB connector of the sound source device 111. In other examples, the hub 120 may be connected to the sound source device 111 through other suitable wire or cable connections or by wireless communication connection. In yet other examples, the hub 120 may be included in the sound source device 111 (e.g., within a common housing with other electronics of the sound source device 111).

The diagram in FIG. 11 also shows a plurality of wireless communication units 112 associated with a corresponding plurality of pads (or other instruments) of the electronic musical instrument system 110. The diagram in FIG. 11 shows three wireless communication units 112 associated with a snare pad, a cymbal pad and a hi-hat pad, respectively, of the electronic musical instrument system 100. Other examples may include more or fewer wireless communication units 112 associated with more or fewer (or different) pads or other instruments. Each of the wireless communication units 112 is configured to communicate, wirelessly, with the sound source device 111.

The sound source device 111 may include some or all of the electronic components as described above with regard to the sound source device 11 and includes further components, firmware or software for controlling processing electronics of the sound source device 111 to perform operations and functions as described herein. In the example in FIG. 11, the sound source device 111 includes sound source electronics 114 having a DAC (e.g., corresponding to the sound source circuit 29 and DAC 30 of the sound source module 11 described above). The sound source electronics 114 may be connected to (or configured to connect to) an amplifier speaker 15 or headphones as described above.

The sound source device 111 may include hub/pad message processing electronics 115 for processing communications to and from the hub 120 and the pads of the electronic musical instrument 110 and providing playing information to the sound source electronics 114. The sound source device 111 may also include a setting screen 116 or other user interface, for example, corresponding to the LCD 25 of the sound source module 11. The sound source device 111 may also include a driver 117, such as, but not limited to a USB driver for transmitting and receiving dedicated messages to and from the hub 120.

In certain examples, the sound source device 111 associates a virtual input port for each type of pad connected to the device, similar to the manner discussed above with regard to the sound source device 11. Accordingly, a tone or other effect is assigned to each virtual input port based on a type of pad. In particular examples, each virtual input port is assigned a different tone or effect relative to each other virtual input port. In other examples, one or more virtual input ports may be assigned the same tone or effect.

For example, when it is detected that a pad (or other instrument) is connected to the sound source device 111 via the hub 120, pad identification information (e.g., corresponding to identification information 52a discussed herein) such as, but not limited to individual information, model information, and type information is acquired by the sound source device 111 from the connected pad (or other instrument). The sound source device 111 selects a virtual input port that is appropriate for the pad (or other instrument) on the basis of the identification information acquired from the pad.

Thus, the sound source device 111 may be configured to associate the virtual input ports with detected pads (or other instruments) based on the identification information acquired from the pads (or other instruments) by the sound source device 111. In particular examples, the associations are provided by data stored by (or provided to) the sound source device 111 for defining a correspondence between virtual input ports and various types of pads (or other instruments) that can be included in an electronic musical instrument system 110. An example of such associations is shown in Table 1 below. In other examples, other suitable associations between virtual input ports and pads (or other instruments) of the electronic musical instrument system 110 may be employed.

TABLE 1

| Pad | Virtual Input Port |
|---|---|
| 5 × 14 Snare | SNARE |
| 6.5 × 14″ Snare | SNARE |
| 5 × 10″ Snare | SNARE |
| 18″ Bass Drum | KICK |
| 20″ Bass Drum | KICK |
| 22″ Bass Drum | KICK |
| Hi-Hat | HI-HAT |
| 14″ Crash | ※See CRASH Assignment |
| 16″ Crash | Algorithm below |
| 18″ Ride | RIDE |
| 8″ Tom | TOM1 |
| 10″ Tom | TOM1 |
| 12″ Tom | TOM2 |
| 14″ Floor Tom | TOM3 |
| 16″ Floor Tom | TOM3 |
| Cowbell | AUX1 |

A crash cymbal assignment algorithm may include assigning a first connected crash cymbal to CRASH1 virtual input port. Then, if a new crash cymbal is connected, and CRASH1 has already been assigned, then the algorithm assigns the new crash cymbal to CRASH2, and so forth. Auxiliary virtual ports may be associated with pads, as well. Accordingly, newly connected crash cymbals may be assigned to virtual input ports in order of detection such as, but not limited to CRASH1, CRASH2, AUX1, AUX2, AUX3, AUX4, and so forth.

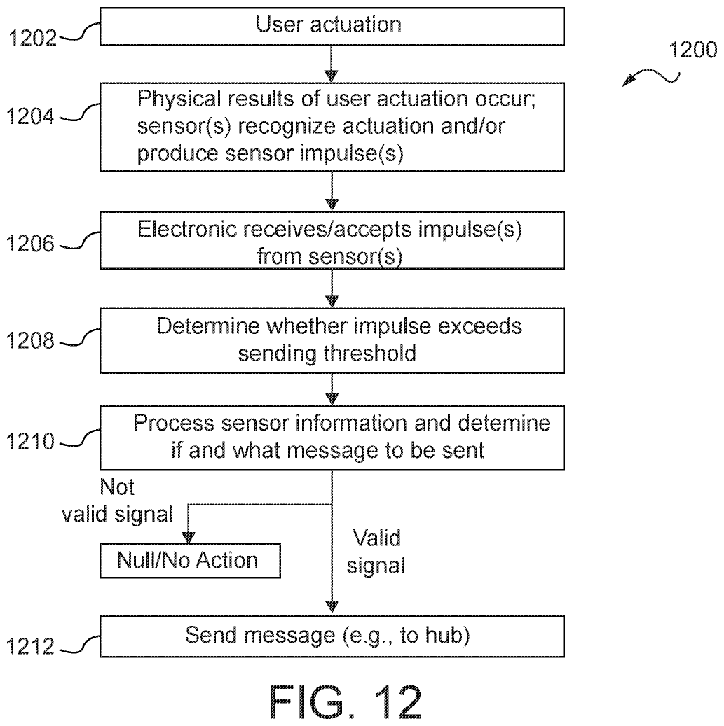

FIG. 12 is a flow chart of a method 1200 according to one embodiment of the present disclosure which can be utilized with various instruments according to the present disclosure, including but not limited to the electronic musical instrument system 110 in FIG. 10 and as specifically described below. It is understood that additional blocks may be included, and/or blocks may be omitted. Upon a user actuating an electronic pad of the electronic musical instrument system 110 (block 1202), the actuation(s) (e.g., through the physical results of the actuation such as, but not limited to: displacement of a drum head, cymbal or pedal; vibration of a drum head, cymbal or other part of the electronic instrument system 110; etc.) are recognized by one or more sensors of the pads (block 1204), which can produce a reaction (e.g., an impulse). The sensors can be linked (e.g. using one or more wires) to a wireless communication unit 112 associated with the pad and having an electronic module (such as, but not limited to the electronic module 200 discussed below). In particular examples, the wireless communication unit 112 is located within a relatively close proximity to the pad (and pad sensors) to which it is linked. For example, the wireless communication unit 112 may be mounted on the stand S, just below or adjacent to that pad, or may be mounted on or located within that pad.

The electronic module 200 of the wireless communication unit 112 includes one or more processors or processing electronics configured to receive/accept information (e.g., impulses) from the one or more sensors (block 1206). The processors or processing electronics are further configured to then perform a logical function (e.g., using a logic gate circuit or software routine) to determine what, if any, message it should send based on the accepted information/impulse(s). In one specific embodiment, the processors or processing electronics are further configured to determine, based upon one or more accepted impulses, 1) whether the impulse from the sensor(s) exceeds a minimum sending threshold (which can help prevent inadvertent transmission of unintended impulses) (block 1208), and 2) if so, process the sensor information and determine if and what message/signal to send (block 1210). In certain examples, the minimum sending threshold can be, for instance, a predetermined voltage that must be caused by one or more of the instrument's piezoelectric sensors. In other examples, the minimum sending threshold can be another predetermined sensor output. If the minimum sending threshold is met, the electronic can then send the determined message to the hub 120 (block 1212).

The system can be configured such that the hub 120, or another recipient-end element, sends an acknowledgment signal when the message from the electronic module 200 of the wireless communication unit 112 is received. The processors or processing electronics of the electronic module 200 can be further configured to include a resend protocol such that if an acknowledgment message is not received within a certain period of time, the electronic module 200 resends the original message. In certain embodiments, the resend time (i.e., the time that passes after which the electronic module 200 will resend if it has not received an acknowledgment signal) is 1 ms or less. This cycle can be repeated until a pre-set timeout, after which the electronic module 200 would no longer attempt to send the original message. Due to the resend time being 1 ms or less, it would take multiple resend attempts before a human would be able to recognize that the original signal had not gone through. In some embodiments, 5 to 100 resends, 25 to 75 resends, or about 50 resends may be attempted before timeout.

In particular examples, the electronic module 200 of the wireless communication unit 112 is configured such that each signal produced and transmitted by the electronic module in response to an actuation of one of the pads of the electronic musical instrument system 110 can be 25 bytes or less; or 20 bytes or less; or 15 bytes or less; or 10 bytes or less; or 5 bytes or less; or 3 bytes or less. In one embodiment a 112 bit/14 byte signal is used. The above signal sizes result in reduced latency and/or a reduced likelihood of interference.

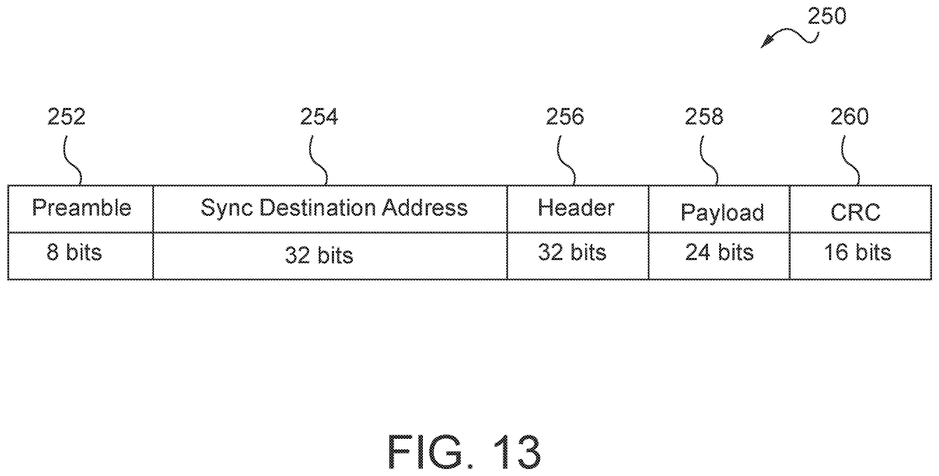

In an even further specific embodiment as shown in FIG. 13, a standardized packet format 250 of 112 bits is divided with 8 bits dedicated to a preamble 252, 32 bits dedicated to a sync destination address 254 identifying the message recipient, 32 bits dedicated to a header 256, 24 bits dedicated to a payload 258, and 16 bits dedicated a CRC 260. It should be understood that messages of various sizes can be divided using these same or different proportions.

Sync addresses (e.g., sync destination addresses 254) can be unique to each product, similar to a serial number, and can be used as the “identifiers” described herein, and could also be used in other manners, such as, but not limited to identifying manufacture date, manufacturer, etc. A portion of the sync address can also identify the type of product (e.g., an electronic musical instrument or a of hub), the sender and/or destination such as a hub or an electronic musical instrument. For instance, a plurality of bits may be consistent among a or each product type. In another embodiment, further differentiation is possible; for instance, each type of electronic pad or other electronic musical instrument may have its own identifier. In one specific embodiment, a first portion (e.g., the first or last 8 bits) of the sync destination address identifies the type of product (e.g., hub or instrument), while another portion (e.g., the other 24 bits) identify the specific hub or instrument. Other embodiments are possible.

Headers 256 can be used for a variety of information such as, but not limited to, retry count (i.e., whether this message is the first, second, etc. attempt to send the same substantive information), the antenna used to transmit the message (e.g., chip or wire antenna), which antenna the recipient should use to receive the message (e.g., chip or antenna), the sequential number of the message (e.g., sequential number of the message since the electronic awoke from sleep mode, which can be independent of retry attempts), and the type of message (e.g., instrument signal based on actuation of instrument, acknowledgment message, etc.). In one embodiment of the disclosure, the sequential number of the message does not reset, and thus serves to indicate to the user how much the electronic musical instrument or the electronic module 200 of the wireless communication unit 112 associated with the instrument has been used.

Payloads 258 can be used to embody a variety of operational variables. For instance, they can (1) identify the sender of the message using a receiver-assigned identifier, and/or (2) include information related to the actuation. In the specific embodiment using MIDI formatting, the payload 258 could include MIDI zone and velocity (i.e., 0-127) information. Signal lengths used in embodiments of the present disclosure can also be relatively short, such as, for example, 250 μs or less in length, 200 μs or less in length, 150 μs or less in length, or less than 100 μ sin length, though it is understood that other lengths are possible. This can also result in reduced latency and/or a reduced likelihood of interference, especially when combined with the above-described signal sizes.

Power savings can be vital in wireless electronic instruments, given that replacement of batteries can be a complicated and time-consuming process, and because power loss at an unexpected time can be undesirable. In certain embodiments, the pads of the electronic musical system 110, such as through the electronic module 200 of the wireless communication unit 112 associated with the instrument (including processing electronics as will be more fully described later in this disclosure), can be controlled to operate utilizing two or more power modes, which can help with power savings. Some power modes according to embodiments of the present disclosure include (1) sleep mode, (2) standby mode, and/or (3) run mode, though it is understood that other modes and any number of modes are possible (e.g., one mode, two or more modes, three or more modes, four or more modes, etc.). It should be understood that when referring to an electronic musical instrument in the descriptions with regard to FIG. 10, instrument power modes, and other descriptions as would be understood by one of skill in the art, this can also refer to the electronic module 200 of the wireless communication unit 112 associated with the electronic musical instrument (to be discussed more fully later in this disclosure), and these same or similar concepts can be applied to a corresponding electronic module 200 of a hub 120. It should also be understood that, when referring to the number of modes, the reference does not include the instrument state where the instrument is completely off, such as because it has been switched completely off or lacks a power source.

Sleep mode: In some embodiments, the electronic module 200 of the wireless communication unit 112 associated with an electronic musical instrument or with a hub can be in sleep mode until it is awoken by an action. In sleep mode, the electronic musical instrument or hub operates in a limited manner and/or has less functionality than other modes so as to conserve power. Power usage in sleep mode can be minimal, such as, for example, 100 μA or less, 50 μA or less, 25 μA or less, 10 μA or less, or about 10 μA, while still being non-zero. In sleep mode, any boost converter (s) and/or analog circuitry can be disconnected and/or powered down to reach these low power usage levels.

The electronic module 200 (or the electronic pad or hub) may be set to wake from sleep mode and transition to standby mode only when a single waking action is recognized, or when any one of a plurality of waking actions are recognized. Exemplary waking actions include, for example, pairing to a hub 120; receiving a connection request (e.g., from a hub 120 or a pad); receiving acknowledgment and/or acceptance (e.g. from a hub 120) of a connection request sent by an electronic pad of the electronic musical instrument system 110; actuation of an electronic pad of the electronic musical instrument system 110 (e.g. striking of a drumhead), which in a more specific embodiment would require actuation of at least a threshold magnitude; receipt of a sensor impulse by the electronic module 200 from a sensor, which in a more specific embodiment would require the impulse to be of at least a threshold magnitude; the operation of a switch, such as a switch in a throw-off; or other embodiments as would be understood by one of skill in the art.

The use of threshold magnitudes in this and other manners can be useful in that threshold magnitudes can avoid an electronic pad of the electronic musical instrument system 110 and/or the system taking action in response to a minor and/or inadvertent stimulus, such as a user brushing against or slightly bumping an instrument, or causing a minor sensor impulse that did not meet the threshold magnitude. Avoiding inadvertent waking reduces unwanted power loss and other unintended actions. The instrument can recognize a stimulus, determine whether the threshold magnitude has been met, and then either take action or not depending on whether the threshold magnitude was met. This block can be similar to or the same as the block 1210 from FIG. 12, or can be different. In one embodiment, whether or not a threshold magnitude has been met is determined by measuring the voltage caused by one or more of an instrument's sensors (e.g., its main piezoelectric sensor) and comparing that voltage to a predetermined threshold voltage. Threshold magnitudes can be pre-set or user-configurable, and can be different or the same for different instruments and sensors, including sensors within the same instrument. The threshold magnitude and/or the determination of whether a threshold magnitude has been met can be made using an analog comparator (e.g., for each sensor), and adjustment of the threshold magnitude(s) can be made by adjusting the comparator bias(es). Threshold magnitudes can also be stored (e.g., in memory of the electronic module 200) and/or adjusted within the electronic module 200.

Sleep mode can be re-entered from other modes upon the meeting of certain pre-set conditions. For instance, in one embodiment, sleep mode of the electronic module 200 (or the electronic pad) is re-entered upon determining that the electronic pad (or the wireless communication unit 112 associated with the electronic pad) is no longer paired to a hub 120. In another embodiment, sleep mode is re-entered upon the passage of a pre-determined amount of time without receiving a stimulus.

Sleep/Scan toggle: In some embodiments the electronic module 200 (or the electronic pad) is not configured to seek such a hub connection while in sleep mode. Instead, the electronic module 200 can temporarily wake from sleep mode to a scan mode, wherein the electronic module 200 sends a connection request to one or more potential pairing partners before returning to sleep mode if no connection is made and/or no acknowledgment is received. This can be done at pre-set time intervals (a “sleep timer”), such as every 1 second or more, every 3 seconds or more, every 5 seconds or more, every 7 seconds or more, every 10 seconds or more, every 30 seconds or more, every 60 seconds or more, every 60 seconds or less, every 30 seconds or less, every 15 seconds or less, every 10 seconds or less, every 7 seconds or less, every 5 seconds or less, every 3 seconds or less, every 1 second or less, combinations of these ranges (e.g., between every 1 second and every 30 seconds or between every 1 and 15 seconds), or other ranges or intervals as would be understood by one of skill in the art. The total time in scan mode for each of these request cycles, including a nominal wake-up time (typically under 100 μs, such as about 10 μs), can in embodiments of the present disclosure be under 1 second, under 500 ms, under 250 ms, under 100 ms, under 50 ms, under 25 ms, under 10 ms, under 5 ms, under 2.5 ms, 500 μs-5 ms, or around 1.5 ms, though it is understood that these ranges are exemplary in nature. The total percentage of time in standby mode for each request cycle can be less than 5%, less than 1%, less than 0.5%, less than 0.1%, less than 0.05%, less than 0.025%, or around 0.02%, though it is understood that these ranges are exemplary in nature.

In one embodiment of this toggling, the electronic module 200 (or the electronic pad) only sends a message seeking connection to one or more preferred hubs 120 as will be described more fully below, such as its most recently connected hub 120. This can minimize the amount of power used and the amount of time in scan mode. It should also be understood that in one embodiment, the electronic module 200 performs this function as part of its sleep mode without toggling to scan mode (which means sleep mode would require more power). The electronic module 200 can send the message on the same frequency or channel that it used during its last connection to the hub 120, or on a plurality of frequencies/channels. In a further specific embodiment, if the electronic module 200 of a wireless communication unit 112 associated with an electronic pad is unable to connect on that frequency/channel, it can then seek connection using a plurality of other frequencies/channels.

Upon successfully linking with a hub 120, the electronic module 200 of a wireless communication unit 112 associated with an electronic pad can perform or complete a transition from sleep mode or scan mode to standby mode within a nominal and/or near-zero amount of time.

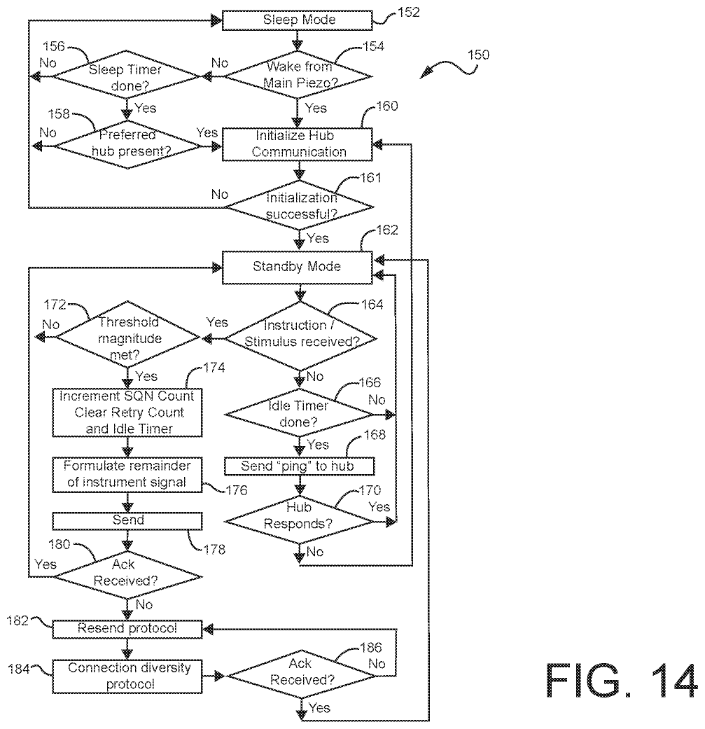

Standby mode: In some embodiments, the electronic module 200 of a wireless communication unit 112 associated with an electronic pad can include a standby mode, which is a partially operational mode with more operational capability than sleep mode and, in some embodiments, scan mode. For instance, in standby mode, the electronic module 200 (or the electronic pad associated with the wireless communication unit 112) can have its analog circuitry and/or boost converter (s) powered, and can be ready to quickly transition to run mode and send an instrument signal. As another example, while in standby mode the instrument/electronic module 200 can be configured to send a ping message to its connected hub 120 after a certain period of inactivity (an “idle timer”) to confirm the connection, or alternatively to confirm that the connection has ended. Examples of standby mode functions will be described below with regard to FIG. 14.

Run mode: In run mode the electronic module 200 of a wireless communication unit 112 associated with an electronic pad is capable of sending and receiving instrument signals to and from a pair partner such as a hub 120. Run mode may include less than all of the functionality of sleep and/or standby modes; for instance, certain other functionalities may not be conducted in run mode, such as seeking a pairing partner/hub 120, because such actions are not necessary. This can result in a reduction in data traffic, thus saving power and resulting in a lower chance of interference. As another example, if profile information of the electronic pad associated with the wireless communication unit 112 is shared as part of the process of connecting the wireless communication unit 112 to the hub 120, then that information need not be communicated when the electronic module 200 of a wireless communication unit 112 associated with the electronic pad is in run mode unless there is a change to that information (e.g., the user sends an instruction that the electronic pad should change from sounding like a first type of drum to a second type of drum).

Standby/Run toggle: As will be more fully described below with regard to FIG. 14, the electronic module 200 of a wireless communication unit 112 associated with an electronic pad can toggle between standby and run modes, such as when the electronic pad is being played by a user. From a standby mode, the electronic module 200 (or the electronic pad) can determine whether it has received an instruction or stimulus (e.g., one meeting a threshold magnitude). If so, then the electronic module 200 (or the electronic pad) can wake from standby mode to run mode to formulate and send an instrument signal and await/receive acknowledgment of receipt from the hub 120.

Similarly, hubs 120 according to certain examples of the present disclosure can also operate utilizing the above-described power modes, with “wake-up” achieved through means such as operation of a sound source device 111 to which the hub 120 is connected or other means such as those described above with regard to instruments and/or those that would be understood by one of skill in the art.

As described above with regard to the power modes, methods according to the present disclosure can include pairing of an electronic pad of the electronic musical instrument system 110 with a hub 120. The electronic module 200 of the wireless communication unit 112 associated with an (or each) electronic pad can be configured to seek connection to a hub 120 in any number of ways. For instance, the electronic module 200 can seek connection to a hub 20 (or vice versa) upon an instruction or stimulus as previously described, and/or at pre-set time intervals as previously described. In some embodiments, the electronic module 200 first seeks connection and/or only seeks connection to a preferred hub 120, such as the hub 120 with which it was most recently connected. The electronic module 200 can seek connection to any hub (as opposed to the preferred hub) in cases where the preferred hub is not found or where there is no record of a preferred hub, such as when the instrument is brand new. For instance, the electronic module 200 of the wireless communication unit 112 associated with an (or each) electronic pad can be configured to broadcast a scan message and listen for a response from any hub (which a hub 120 may send while in pairing mode, which can be instituted by the user). In one embodiment, the electronic module 200 can be configured to seek connection through a priority list of hubs stored in memory of the electronic module 200, such as from the most recently paired (most preferred) to the oldest paired (least preferred), prior to seeking connection to any non-preferred hub. In one embodiment, if the electronic module 200 is seeking connection at pre-set time intervals, it may only seek connection to a previously paired hub(s), for example only to its most recently paired hub. Hub preferences, such as the most preferred hub or a preferred hub list (which could use the identifiers of the preferred hub(s)) can be stored in memory of the electronic module 200.

As part of its communication with a hub 120, the electronic module 200 of the wireless communication unit 112 associated with an electronic pad can also share information regarding that electronic pad. By way of example, the electronic module 200 can send or receive instrument profile information and/or settings to or from the hub 120.

Instrument profile information could include, but is not limited to, non-configurable information, identifier(s) and/or identifying information (e.g. serial number), firmware information, instrument information (e.g. instrument type, instrument size, manufacturer(s), custom modifications, instrument usage information (e.g., how much has the instrument been played), etc.), and/or other information as would be understood by one of skill in the art.

Settings can include, but is not limited to, instrument settings configurable by a user, digital instrument information (i.e., information about the sounds of the instrument which the electronic instrument is to emulate, such as make, model, shell type, size, head information, and the like), sound settings (e.g. volume settings and post-processing settings such as transient shaping, reverb, delay, etc.), and/or other information as would be understood by one of skill in the art. The settings, and particularly the settings that vary based on usage or user-selected configuration, can be saved within an instrument (e.g., via memory of the wireless module 200) whenever electronic module 200 is disconnected from a hub 120, so that they can be utilized the next time the electronic module 200 connects to that hub 120 and/or a different hub.

Sharing of information profile and/or settings can take place at any number of different times, as will be discussed with regard to the below instrument-hub connection example.

An example method 150 for operating a musical instrument system 110 is described with reference to FIG. 14. The method 150 is only an example, and numerous other embodiments are contemplated. For instance, blocks shown in FIG. 14 may be omitted, blocks may be combined with one another, blocks may take place in an order different than that shown, and/or additional blocks may be included. It should also be understood that while this example refers to the “instrument” taking action, this action could specifically be taken by a component of the electronic pad, the electronic module 200 of the trigger device associated with the electronic pad, a sensor, etc. It should also be understood that a plurality of electronic pads of the electronic musical instrument system 110 may be performing this method at the same time, with the same hub 120 or with different hubs.

Blocks shown or described as taking place during a certain instrument mode may also take place exclusively in one or more different mode(s) not shown/described, or in multiple modes including or excluding the mode shown/described. With regard to FIG. 14, examples of sleep mode blocks include blocks 152, 154, and/or 156; examples of scan mode blocks include blocks 154 (which serves as an impetus to change from sleep mode to scan mode), 158, and/or 160; examples of standby mode blocks include blocks 162, 164, 166, 168, 170, and/or 172; and examples of run mode blocks include blocks 172 (which serves as the transition point between standby mode and run mode if the threshold magnitude is met), 174, 176, 178, 180, 182, 184, and/or 186.

Turning to an example of a method 150 according to the present disclosure, once the instrument is connected to a power source and/or turned on, in block 152 it can be in sleep mode such as that described above. In block 154, a waking action may occur, such as an impulse from a specific sensor (e.g., a primary piezoelectric sensor of the instrument, such as the center drumhead piezoelectric sensor of a drum). As the instrument awaits a waking action, it can cycle through its sleep timer checks (block 156) as described above with regard to the sleep mode/scan mode toggle to determine whether a hub (e.g., a preferred hub) is present (block 158). It should be understood that the instrument could also go into scan mode and determine whether the hub is present (block 158) after block 154 and prior to block 160. In block 158, in one embodiment scan mode utilizes only the channel on which it was last connected to determine whether a hub 120 is present; in another embodiment, it utilizes a plurality of channels, such as all available channels.

Once either the condition from block 154 or block 158 is met, the instrument can attempt to initialize communication with the hub 120 in block 160. In block 160, the instrument can attempt to initialize communication (e.g., in the manner described above with regard to a sleep/scan toggle) utilizing only the channel on which it was last connected to determine whether a hub is present, utilizing a plurality of channels, or using all available channels. In one embodiment, block 160 utilizes more channels than block 158. Examples of channels that can be used will be discussed further below. In block 161, the instrument determines whether initialization was successful. If initialization is not successful, then the instrument can return to sleep mode 152 and re-cycle through the previously described blocks. If initialization is successful, then the instrument can enter standby mode 162.

While in standby mode 162, in block 164 the instrument can be monitoring for an instruction or stimulus (referred to hereinafter as “stimulus” for simplicity), such as monitoring one or more terminals 202 of the wireless module 200. Assuming no stimulus has been received, the instrument will continue to monitor for a stimulus until it determines in block 166 that a pre-determined period of time has passed, i.e., that the idle timer has expired. The idle timer can be, for instance, between 10 seconds and 10 minutes, 30 seconds and 5 minutes, 1 minute and 3 minutes, about 2 minutes, greater or less than any of these times, or combinations of these ranges, though it is understood that these times are only exemplary in nature and other times are possible.

Upon determining that the idle timer has expired, in block 168 the instrument will send a “ping” message to the hub 120 to confirm that a connection still exists. In block 170, the instrument will determine whether or not the hub 120 responded to the ping message. If the hub 120 responded, the instrument will return to standby mode 162 and the idle timer will reset. If the hub 120 does not respond, then the instrument can return to block 160 to attempt to initialize a hub connection, or to another block or state such as sleep mode 152.

If a stimulus 164 is detected, then in block 172 the instrument can determine whether or not the stimulus 164 met a threshold magnitude. If the stimulus 164 did not meet the threshold magnitude, then the instrument can return to standby mode 162 and re-cycle through the described blocks. The threshold magnitude for the stimulus 164 can be less than a threshold magnitude for a stimulus in block 154 used to wake the instrument from sleep mode 152; that is, a higher magnitude stimulus (e.g., a higher velocity strike) may be required to wake the instrument from sleep mode 152 than the threshold stimulus that results in the sending of an instrument signal.

If the stimulus 164 meets the threshold requirements, then the instrument can enter run mode. In block 174, the sequential number of the message (previously described) will be assigned, and the retry count and idle timer will be reset by the instrument. In block 176, the remainder of the instrument signal will be formulated (e.g., from sensor inputs), and in block 178 the instrument signal will be sent. The instrument will then monitor for an acknowledgment message from the hub 120 and determine whether or not such a message has been received (block 180). The instrument (e.g., through its wireless module 200 and/or transceiver) can change to receive” mode while awaiting an acknowledgment message. Acknowledgment messages according to certain examples can include the same sequential number as the received instrument signal so as to properly identify the instrument signal that is being acknowledged.

Once an acknowledgment message is received, the instrument returns to standby mode 162. If an acknowledgment message is not received, then the instrument can enter its resend protocol 182 and/or its connection diversity protocol 184, both described in detail elsewhere in this disclosure. This can take place after a pre-set time after the sending of the instrument signal during which an acknowledgment message was not received, such as, for example, at least 50 μs, at least 100 μs, at least 250 μs, at least 400 μs, immediate (˜0 or nominal), less than 5 ms, less than 2 ms, less than 1 ms, less than 500 μs, ranges between any of these times, and/or about 430 μs. In one embodiment, the time prior to re-send is varied. For instance, the re-send time can be varied and/or randomized among a plurality of potential re-send times (e.g., immediate, 320 μs, 640 μs, and/or 960 μs), or within a range of potential re-send times, such as the ranges discussed above. Different instruments (e.g., electronic pads) in an electronic musical instrument system 110 can have different re-send times or protocols so as to avoid the rare situation where two or more signals are produced at the exact same time and enter re-send protocols having the exact same timing.

In block 186, if an acknowledgment is eventually received, the instrument can return to standby mode 162. If, on the other hand, no acknowledgment is received after the completion of the resend protocol 182 and/or connection diversity protocol 184 as applicable, then in some embodiments the instrument can return to blocks 182,184 to repeat the resend and/or connection diversity protocols. If the maximum number of attempts is eventually reached without an acknowledgment being received, the instrument returns to block 160 (initializing a hub communication) and/or standby mode 162, or other blocks as would be understood by one of skill in the art.

In one block not shown in FIG. 14, prior to sending an instrument signal in block 178, the instrument can perform a check of the wireless radio frequency. If the frequency is busy or being used already, such as by another instrument in the electronic musical instrument system 110, then the instrument can delay sending the instrument signal for a short period of time (e.g., 1 ms or less, 500 μs or less, 100 μs-500 μs, or about 270 μs) before either sending the signal or performing another check to see if the frequency is clear.

In some embodiments, a single hub 120 is used to receive a plurality of signals from a corresponding plurality of electronic pads (or other individual instruments) of an electronic musical instrument system 110, and thus produce sounds (through one or more sound source devices 111) from each of those instruments. In further embodiments, a single hub 120 may be used to receive signals from electronic pads (or other individual instruments) of two or more electronic musical instruments 110. For instance, a single hub 120 can be used to receive signals from 1) a snare drum, 2) one or more toms, 3) a bass drum, 4) one or more cymbals, and 5) a hi-hat cymbal, or any other suitable combinations of electronic pads of one or more electronic musical instruments 110. The previously-described connection methods can be utilized to connect one or more electronic pads of an electronic musical instrument system 110 in the above-described manners to that hub 120 while that hub 120 is already connected to one or more other electronic pads. It should be understood that any ratio of instruments and hubs is possible, in some cases with fewer hubs than instruments, and in an even more specific embodiment with multiple instruments connected to a single hub.

In certain examples, multiple electronic modules 200 that are sending signals from multiple respective electronic pads as part of a system can transmit messages to the same hub 120 on the same frequency. Because of the relatively small size and/or message length of each message as discussed above, there is a low chance of interference. In further examples, each of two or more electronic modules 200 of an electronic musical instrument system 110 (e.g., the electronic modules for different electronic pads of an electronic drum set) can be set with a different resend time or protocol, or a varied/randomized protocol as previously described. This can stagger resends should two messages from respective electronic modules happen to interfere with one another, such as if a drummer were to actuate two or more electronic pads of the electronic musical instrument system 110 at the exact same time. If the resend protocols of the electronic modules 200 in the electronic musical instrument system 110 were set with the exact same resend time, this could result in an interference loop, whereas staggering resend times increases the likelihood that the messages will be sent at different times and thus not interfere with one another. Should two or more messages collide, the resend protocol methods described herein will likely result in all messages being received with only a very slight delay that would not cause any noticeable change in sound production.

The use of a single frequency for the sending of all messages from the various electronic pads of the electronic musical instrument system 110 can both: a) lessen the chance of outside interference, and b) simplify the system as a whole, in that multiple frequencies for each of various electronic pads do not have to be used. In some embodiments, all electronic modules of an instrument group, such as for the drum pads of a drum set, utilize the same frequency. In some other embodiments, two or more electronic pads of the electronic musical instrument system 110 each use their own respective frequency. In other embodiments, two or more electronic pads of an electronic musical instrument system 110 may employ a single, common frequency, while one or more other pads of the electronic musical instrument system 110 may employ one or more different frequencies.

In one embodiment, all messages sent to the hub 120 by the various electronic pads of the electronic musical instrument system 110 may use a first frequency (or a first plurality of frequencies), while all acknowledgment messages sent by the hub 120 use a second (different) frequency (or a second plurality of frequencies each different than each of the first plurality of frequencies). This prevents the collision of data/instrument signals (from the instrument electronic modules 200) and acknowledgment signals (from the hub 120). Generally speaking, this results in lower message failure than embodiments where the data signals and acknowledgment signals use the same frequency; however, it is understood that embodiments with the data and acknowledgment signals on the same frequency are possible, and that other interference avoidance techniques may be employed.

In one embodiment, the electronic module 200 of a hub 120 and of an electronic pad of the electronic musical instrument system 110 utilizes a plurality of channels, with a “channel” being defined herein as a pair of frequencies where one direction of transmission (e.g., instrument-to-hub, such as an instrument signal) occurs on the first frequency while the other direction of transmission (e.g., hub-to-instrument, such as an ack signal) occurs on the second frequency. In one embodiment utilizing a channel method, any number of channels may be used. A greater number of channels can provide greater versatility for finding open frequencies and avoiding interference, while a lesser number of channels can provide for simplicity and power savings, since during some channel scanning actions fewer channels will need to be scanned. Some embodiments utilize two to ten channels, three to six channels, or four channels, though it is understood that these are exemplary in nature and any number of channels is possible. In some embodiments, all channel frequencies are within a certain range of one another, such as all channel frequencies being within 250 MHz of each other, or within 100 MHz of each other. By way of example only, in a four channel system, Channel 1 could transmit at 2402 MHz & 2423 MHz, Channel 2 could transmit at 2426 MHz and 2448 MHz, Channel 3 could transmit at 2451 MHz and 2476 MHz, and Channel 4 could transmit at 2480 MHz and 2472 MHz. Any of these channel frequencies may be adjusted, such as being adjusted by ±10 MHz, ±5 MHz, ±3 MHZ, ±1 MHZ (e.g., the first frequency of Channel 1 could be between 2392 MHz and 2412 MHz, etc.). This channel spacing selection can reduce or minimize the amount of interference with traditional Wi-Fi channels 1 (2412 MHz), 6 (2437 MHz), and 11 (2462 MHZ). It is understood that fewer than all of these channels could be used, or that additional channels could also be used.

While in certain embodiments, a hub 120 may initiate communication with one or more electronic pads (or other instruments) to which it is connected, in some other embodiments the hub 120 does not initiate communication. In those embodiments, a hub 120 may need to inform the electronic module 200 of the wireless communication unit 112 associated with the electronic pad (or other instrument) that the hub 120 has a message that needs to be sent. The hub 120 can indicate to the instrument that the hub 120 has a pending message via a portion of its acknowledgment message, such as in the ack message's header. Receipt of such a message can serve as an instruction to the electronic module 200 to transition from standby mode to run mode, thus enabling receipt of the full hub message, or otherwise to configure itself to receive a hub message (e.g., by powering antenna(s)).

In some embodiments, changes to settings (e.g., configurable settings) can be communicated to the hub 120 from the instrument, or vice versa, while in the run mode. For instance, the hub 120 may receive instructions from a sound source device 111 to which it is connected to adjust a configurable setting for a certain instrument, and transmit these instructions to the instrument, such as in the manner described above with regard to the hub sending a “pending message(s)” indicator as part of an ack message. In another embodiment, firmware updates or replacements can be transmitted in this manner.

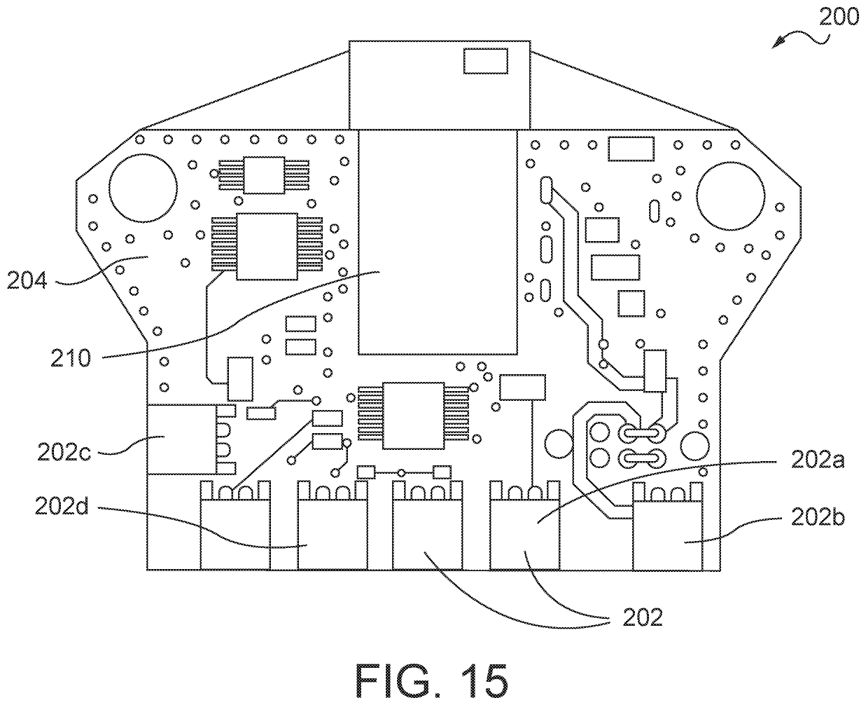

FIG. 15 shows one embodiment of an electronic module 200 according to certain examples of the present disclosure. The electronic module 200 may be included in each wireless communication unit 112. In some examples, an electronic module 200 may also be included in the hub 120 of the electronic musical instrument system 110. The wireless communication unit 112 includes a power source, such as a battery (not shown) for operating the electronic module 200. In particular examples, the wireless communication unit 112 (or electronic module 200 thereof) is individually set for an associated electronic pad (or other electronic instrument), such as, but not limited to a snare drum, one or more toms, a bass drum, one or more cymbals, and a hi-hat of the electronic musical system 110, and striking signals or the like from each respective electronic pad are transmitted to the hub 120 via the wireless communication unit 112 associated with the electronic pad.

In one embodiment, the electronic module 200 is provided on two or more circuit boards (e.g., PCBs), which may or may not be connected together, such as via soldering, microstrip, or other means known in the art. A first board 204 (referred to herein as the “primary board”) can include all of the sensor terminals, the power supply, and analog circuitry, and a second board 210 (referred to herein as the “module board”) can include processing electronics such as one or more microprocessors and transceiver or other radio circuitry for wireless communication. Inter-board connections between the two or more boards may be used to connect them.

Terminals 202 of the electronic module 200 may be configured to receive signals from different sensors. For example, the sensor terminal 202a may be wired to accept sensor impulses from a drumhead sensor caused by a strike on a drumhead, while the sensor terminal 202b may be wired to accept impulses from a sensor configured to detect drumhead vibration. In some other embodiments, the different terminals may be designed for different electronic pads (or other instruments) of the electronic musical instrument system 110. For instance, while the terminals 202a, 202b may be designed for a snare drum, the terminal 202c, 202d may be configured for connection to a hi-hat or a cymbal assembly. In this way, the same electronic module 200 can be used for many different percussion instruments, and in some embodiments the same type of electronic can be used for all of the electronic pads in the electronic musical instrument system 110 (corresponding to all of the percussion instruments in a drum set). Differentiations for types of electronic pads (e.g., designating one electronic module 200 as being associated with a snare drum and another electronic module 200 as being associated with a bass drum) can be accomplished via firmware or software. In some embodiments, each terminal can be capable of use with all types of electronic pads of an electronic musical instrument system 110, with the differences based on type of instrument implemented via firmware or software associated with the processing electronics. While the terminals 202 in the embodiment shown in FIG. 15 are shown on the primary board 204, other embodiments are possible. The module board 210 of the electronic module 200 can include any combination, with or without additional components, of:
a transceiver (such as a 2.4 GHz or 5 GHz FSK transceiver);
a core processor with memory (e.g., flash memory) and RAM (e.g., SRAM) (in one specific embodiment, 512 kb of flash memory and 128 kb of SRAM, though it is understood that this is purely exemplAry in nature);
an analog-to-digital converter, which can be used to measure sensor inputs;
an analog comparator, which can be used for sensing wake-up actuations;
a timer, which can be used for determining mode transitions (e.g., after a predetermined dormancy time, transitioning to sleep mode; after a predetermined time, transitioning from sleep mode to standby mode to send a connection request; etc.);
a signal booster;
a shield to protect from interference;
one or more serial peripheral interface (SPI) modules, which can be used for communication with the digital potentiometers;
touch sensing input, which can be used for capacitive sensing; and/or
a unique identifier for identification of each electronic (and thus its associated instrument), with one example being an 80-bit unique identification number for each chip.

In certain examples additional elements or fewer elements than those listed above are included in the electronic module 200. Moreover, the elements of the electronic module 200 could be arranged differently, such as all on a single board, in a different arrangement on two boards, or on three or more boards.

An electronic module 200 according to examples of the present disclosure can utilize some or all of their sensor terminal inputs to determine how to interpret received sensor impulses, such as by using the firmware or software associated with the processing electronics of the electronic module 200.

This determination can also be made by using a mode setting of the electronic module 200, which can correspond to the type of electronic pad or other instrument being associated with the electronic module (e.g., snare, tom tom, bass drum, cymbal, hi-hat, or other instrument). In some embodiments, the electronic module 200 of a wireless communication unit associated with an electronic pad can determine the magnitude of an impulse detected by each sensor for each actuation of the associated electronic pad, and can use this data in combination with other data, such as the mode setting, to determine the instrument signal that should be sent to the hub 120.

In certain examples, instruments and electronic modules 200 according to the present disclosure can utilize connection diversity to improve quality and robustness of wireless connections. By way of example, each of a hub 120 and one or more electronic pads (or electronic modules 200 associate with the electronic pads) of the electronic musical instrument system 110 can include multiple antennas, and be capable of switching which antenna is receiving and/or transmitting. The other of the antennas can be dormant and/or powered down while the transmitting/receiving antennas are sending and receiving signals. The multiple antennas can include the same or different types of antennas. In one specific embodiment, each of the hub 120 and one or more electronic pads (or electronic modules 200 associate with the electronic pads) includes at least one wire antenna and at least one chip antenna, which can be beneficial in that either of these antenna types may perform better depending on the communication environment. By way of example, an electronic module 200 can be configured to recognize that it is performing poorly and/or has hit a low performance threshold, such as if it does not receive a certain threshold number or percentage of acknowledgment signals in response to transmitted signals. Examples of low performance thresholds can be, for example, a 0.1% failure rate, a 0.5% failure rate, a 1% failure rate, a 2% failure rate, a 3% failure rate, a 5% failure rate, a 10% failure rate, 1 missed acknowledgment, a plurality of missed acknowledgments 2 missed acknowledgments, 3 missed acknowledgments, 5 missed acknowledgments, or other failure rates as would be understood by one of skill in the art. Different instruments and/or hubs can all have the same low performance threshold, or can have different low performance thresholds. Moreover, different antennas within the same instrument and/or hub can all have the same low performance threshold or can have different low performance thresholds.

Once a low performance threshold is hit, the electronic pad or the hub 120 associated with the low performance is configured (e.g., through its respective electronic module 200) to change its operative antenna, such as from a chip antenna to a wire antenna or vice versa. The electronic pad or hub 120 can also, in some embodiments, be configured to send a signal to its counterpart hub 120 or electronic pad (e.g., an electronic module 200 associated with an electronic pad sending a change signal to an electronic module 200 associated with a hub 120) to change which antenna is operative, such as through its own original antenna or the antenna to which the instrument/hub is changing. The change signal can be its own signal, or can be embedded within another signal. The change signal can be on a re-send protocol, such as resending until acknowledgment is received from the other electronic module 200, and/or until a signal from the other electronic module 200 is sent that confirms the other electronic pad or hub 120 has received the message and/or changed antennas.

The electronic pad or hub 120 can stay on its second antenna indefinitely, for a set period of time, until another (or the same) low performance threshold is hit using the new antenna, until the performance of the new antenna becomes worse than the performance of the previous antenna, and/or until the low threshold of the old antenna is passed using the new antenna. In one specific embodiment, the electronic pad changes antennas every time an acknowledgment is missed. Other embodiments are also possible. In some embodiments, the electronic pad can recognize that a low performance threshold has been hit (such as in the manner described above) and/or send change signals such as those described above while in run mode and/or while being played by a user.

Hubs 120 according to certain examples of the present disclosure can utilize different respective antennas for different respective electronic pads (or other instruments). By way of example, if a hub 120 and all instruments connected for communication to the hub are utilizing their respective first antennas (e.g. chip antennas), and less than all of the connected instruments reach low performance thresholds, then the electronic module 200 associated with those specific instruments can send the change signal such that the hub 120 and each of those specific instruments change to their respective second antennas (e.g. wire antennas) with respect to signals between the hub 120 and those specific instruments, while the hub 120 and the other instruments of the electronic musical instrument system 110 may continue to use their respective first antennas for communications therebetween. In another embodiment, a change signal from one system component can order the change for all system components or multiple other system components. By way of example, in one embodiment, if a low performance threshold is reached with one instrument, the hub 120 could send a change signal to all instruments of the electronic musical instrument system 110. In another embodiment, if a low performance threshold is reached with respect to less than all of the instruments, the hub 120 could send a change signal to only those low performing instruments. In those or other embodiments of the present disclosure, the hub 120 determines which of its antennas is working better for more of the instruments to which it is connected, and uses that antenna.

While various example embodiments are described with regard to two-antenna systems, other embodiments may employ the same or similar concepts to systems having three or more antennae. It should be understood that the above wireless connection devices, systems, and methods can be applied to any of the devices, systems, and methods described throughout this disclosure, and to other known devices, systems, and methods.

Components of an electronic musical instrument system 110 may be configured for connection and initial pairing in any suitable manner. In one example, a sound source device 111 is connected for communication to a hub 120 by, for example, but not limited to, a USB connection terminal on the sound source device 111 and a USB cable. In another example, the hub 120 is included in (and already connected to) the sound source device 111 and does not require a further connection.

The sound source device 111 may include one or more buttons or other operators a user may operate to initiate a pairing operation for pairing (or re-pairing) one or more pads or other instruments to the hub 120. In some examples, the one or more buttons are associated with function identifiers displayed on a display screen of the sound source device 111 (for example, corresponding to the screen 116).

Once a user operates the appropriate button or buttons to initiate a pairing operation, the user may strike each pad (or operate each instrument). In certain examples, each pad that the user desires to pair with the hub 120 is struck once. In other examples, each pad may be struck more than once or a pre-defined number of times. The pad strikes result in signals being sent by the wireless communication units 112 associated with the struck pads, and received by the hub 120, as described above.

The hub 120 or the sound source device 111 (or a combination of both) processes the signals received by the hub 120 and identifies the pads (or other instruments) based on identification information received in the signals (such as, but not limited to identification information 52a). In particular examples, the sound source device 111 associates a virtual input port with each identified pad (or other instrument) based on the identification information. The identities of the pads (or other instruments) and their associated virtual input ports may be saved in memory associated with the hub 120 or the sound source device 111 (or a combination of both) for use in processing further signals received from the pads.

Thereafter, a user may end the pairing operation by operating one or more buttons (the same or other buttons as used to initiate the pairing operation). In some examples, once the pairing operation is ended, each of the paired pads may communicate with the sound source device 111, through the hub 120 for additional functions such as, but not limited to calibrating functions that allow a user to calibrate or set sensors in the pad (or other instrument), adjust or set sensitivity values for the pad, or make other settings to associate with signals received from the pad.

In certain example embodiments, an electronic pad (or other electronic instrument) according to the present disclosure can have interchangeable and/or removable parts such that they can be used as an electronic instrument or an acoustic instrument. For instance, an electronic pad of the electronic musical instrument system 10 or 110 can have a drumhead or a set of drumheads (or other striking surfaces) that is/are relatively quiet when struck, such as mesh, PET, polyester, or rubber drumheads (or other materials as known in the art, such as those traditionally used with electronic drums), for use when the drum is in electronic mode and/or when electronic components are in place. The same electronic pad may have another drumhead or set of traditional drumheads made of traditional acoustic materials, such as Mylar and plastics, or other materials known in the art, for use when the drum is in acoustic mode and/or when electronic components are not in place. It should be understood that the above materials listings are exemplary in nature and not limiting; for instance, in certain instances, a material described above as a typical electronic material may be used as an acoustic material and vice versa, depending on user choice. These concepts can be applied to, for example, snare drums, tom toms, bass drums, congas, bongos, timbales, timpani/tympani/kettle drum(s), cymbals, hi-hats, and other instruments as would be understood by one of skill in the art.

It is understood that the electronics described herein could also be used with a traditional drumhead, such that the sound produced by actuation would be the combination of a traditional acoustic sound and an electronic sound. It is further understood that the electronics portion could remain in place and/or remain attached to the drum but be inactive, so that when a traditional drumhead is used, an acoustic sound is produced without any electronic sound. The electronics portion can be mechanically designed so as to, to the extent possible, avoid interfering with the acoustic sound when the electronics portion is “off.” For instance, the electronics portion of a snare drum can contact less than 20% of the inner wall area of a drum shell, less than 10% of the inner wall area of the drum shell, less than 5% of the inner wall area of the drum shell, less than 2.5% of the inner wall area of the drum shell, less than 1% of the inner wall area of the drum shell, or less. The contact with the inner wall area of the drum shell can, in some embodiments, be substantially symmetrical about the radius of the drum shell.

In certain examples described herein, the sound source device 11 or 111 processing electronics or method of operating receives identification information from at least one of the first playing operation devices, associates a tone or effect to the at least one first playing operation device based on the identification information received from the at least one first playing operation device, and receives first playing information from the at least one first playing operation device. A musical sound signal generating unit generates a musical sound signal on the basis of the first playing information received from the at least one first playing operation device and the tone or effect associated with the first playing operation device.

In certain examples described herein, the sound source device 11 or 111 processing electronics or method of operating provides at least one virtual input port, assigns a different respective tone or other effect to each virtual input port, associates each respective first playing operation device with a respective virtual input port, and receives first playing information from at least one of the first playing operation devices. A musical sound signal generating unit generates a musical sound signal on the basis of the first playing information received from the at least one first playing operation device and the tone or other effect assigned to the respective virtual input port associated with the at least one first playing operation device.

In various embodiment described above, the sound source device 11 or 111 is used for an electronic drum system having one or more electronic pads that detect percussion beats. However, the application is not limited thereto, and aspects of the present invention can be applied to electronic musical instrument systems having one or more other instruments (for example, an electronic piano, an electronic guitar, or the like) that generate playing information.

What is claimed is:

1. A sound source device for an electronic musical instrument having a plurality of different types of first playing operation devices, the sound source system comprising:
processing electronics configured to:
receive identification information from at least one of the first playing operation devices,
associate a tone or effect to the at least one first playing operation device based on the identification information received from the at least one first playing operation device, and
receive first playing information from the at least one first playing operation device; and
a musical sound signal generating unit that generates a musical sound signal on the basis of the first playing information received from the at least one first playing operation device and the tone or effect associated with the first playing operation device.

2. The sound source device of claim 1, wherein, to associate a tone or effect to the at least one of the first playing operation device, the processing electronics is configured to:
provide at least one virtual input port;
assign a different respective tone or effect to each virtual input port; and
associate each different respective virtual input port with a different respective first playing operation device.

3. The sound source device of claim 1, wherein the identification information comprises at least one of model information or information representing a type of first playing operation device.

4. The sound source device of claim 1, wherein, to receive identification information from the at least one first playing operation device, the processing electronics is configured to:
detect that the at least one first playing operation device is connected for communication; and
acquire identification information from the at least one first playing operation device detected to be connected for communication.

5. The sound source device of claim 1, wherein the identification information comprises information representing a type of first playing operation device from among a snare drum type, a kick drum type, a tom drum type, a hi-hat cymbal type, a ride cymbal type, and a crash cymbal type.

6. The sound source device of claim 1, wherein the at least one first playing operation device comprises a plurality of first playing operation devices, and the at least one virtual input port comprises a plurality of virtual input ports.

7. The sound source device of claim 1, wherein the processing electronics is configured to receive the identification information over a wireless communication connection.

8. A sound source system comprising the sound source device of claim 1 and further comprising a respective wireless communication unit connected to each respective first playing operation device for wireless communication of the identification information and the first playing information to the sound source device.

9. The sound source system of claim 8, further comprising a wireless communication hub included in or connected to the sound source device and connected for wireless communication with each respective wireless communication unit.

10. The sound source system of claim 8, further comprising at least one sound generating device connected to the musical sound signal generating unit, for generating an audible sound based on the musical sound signal generated by the musical sound signal generating unit.

11. A sound source device for an electronic musical instrument having at least one first playing operation device, the sound source device comprising:
control electronics including processing electronics configured to:
provide at least one virtual input port,
assign a different respective tone or other effect to each virtual input port,
associate each respective first playing operation device with a respective virtual input port, and
receive first playing information from at least one of the first playing operation devices; and
a musical sound generating unit that generates a musical sound signal on the basis of the first playing information received from the at least one first playing operation device and the tone or other effect assigned to the respective virtual input port associated with the first playing operation device.

12. The sound source device of claim 11, wherein to associate each respective first playing operation device with a respective virtual input port, the processing electronics is further configured to:
receive identification information from each first playing operation device; and
associate a tone or effect to each first playing operation device based on the identification information received from each first playing operation device.

13. The sound source device of claim 12, wherein the processing electronics is configured to receive the identification information over a wireless communication connection.

14. The sound source device of claim 11, wherein the at least one first playing operation device comprises a plurality of first playing operation devices, and the at least one virtual input port comprises a plurality of virtual input ports.

15. The sound source device of claim 11, wherein the processing electronics is configured to receive the first playing information over a wireless communication connection.

16. A sound source system comprising the sound source device of claim 11 and further comprising a respective wireless communication unit connected to each respective first playing operation device for wireless communication the first playing information to the sound source device.

17. The sound source system of claim 16, further comprising a wireless communication hub included in or connected to the sound source device and connected for wireless communication with each respective wireless communication unit.

18. The sound source system of claim 16, further comprising at least one sound generating device connected to the musical sound signal generating unit, for generating an audible sound based on the musical sound signal generated by the musical sound signal generating unit.

19. The sound source system of claim 16, wherein:
to associate each respective first playing operation device with a respective virtual input port, the processing electronics is further configured to:
receive identification information from each first playing operation device; and
associate a tone or effect to each first playing operation device based on the identification information received from each first playing operation device; and
the sound source system further comprises:
a wireless communication hub connected to or included in the sound source device; and
a respective wireless communication unit connected to each respective first playing operation device for wireless communication of the first playing information and the identification information to the wireless communication hub.

20. A method of providing musical sound signal for an electronic musical instrument having at least one first playing operation device, the method comprising:
providing at least one virtual input port,
assigning a different respective tone or other effect to each virtual input port,
associating each respective first playing operation device with a respective virtual input port;
receiving first playing information from at least one of the first playing operation devices; and
generating a musical sound signal on the basis of the first playing information received from the at least one first playing operation device and the tone or other effect assigned to the respective virtual input port associated with the first playing operation device.
